(19) United States
(12) Patent Application Publication
(10) Pub. No.: US 2026/0009376 A1
(43) Pub. Date: Jan. 8, 2026

(54) SOLAR ENERGY SYSTEM WITH THERMAL ENERGY STORAGE

(71) Applicant: Holtec International, Camden, NJ (US)

(72) Inventors: Krishna P. SINGH, Jupiter, FL (US); Edward BELL, Medford, NJ (US); Indresh RAMPALL, Cherry Hill, NJ (US)

(73) Assignee: Holtec International, Camden, NJ (US)

(21) Appl. No.: 19/262,978

(22) Filed: Jul. 8, 2025

Related U.S. Application Data
(60) Provisional application No. 63/668,364, filed on Jul. 8, 2024.

(51) Int. Cl. F03G 6/06; F03G 6/00

(52) U.S. Cl. CPC F03G 6/065; F03G 6/071

(57) ABSTRACT

A solar energy system with thermal energy storage comprises a vessel defining an internal cavity including a partition structure forming multiple vertical heat transfer cells. Each cell is formed by vertical cell walls of the partition structure. Each heat transfer cell contains a separate inventory of a thermal mass composition operable to store thermal energy. A heat exchanger disposed in each cell comprises first and second tube bundles embedded in the thermal mass composition. The first bundle circulates heat transfer fluid heated by solar energy to heat the composition. The second bundle circulates working fluid such as water converted to steam by absorbing heat from the composition for generating power or other steam applications. The cells may be formed by discrete self-supporting transportable tubular modules each supporting one of the heat exchangers. Each cell and heat exchanger therein are independently operably of the others.

### CROSS-REFERENCE TO RELATED APPLICATIONS

The present application claims the benefit of priority to U.S. Provisional Application No. 63/668,364 filed Jul. 8, 2024, U.S. Provisional No. 63/671,336 filed Jul. 15, 2024, and U.S. Provisional No. 63/675,394 filed Jul. 25, 2024. The foregoing applications are all incorporated herein by reference in their entireties.

### FIELD OF THE INVENTION

The present invention relates to solar energy systems, and more particularly to such a system which utilizes solar energy to heat a heat transfer fluid which heats a thermal mass composition operable to retain heat, which in turn heats a secondary working fluid such as water to produce steam for generating electric power via the Rankine cycle or for other uses.

### BACKGROUND OF THE INVENTION

Thermal energy reaching earth from the sun is quite immense. Yet, harnessing it for useful purposes has been difficult. For over 200 years, fossil fuels excavated from the ground have been the mainstay for energy supply needed to support human civilization. Solar energy, although ubiquitous and visibly strong between the equatorial and subtropical regions of the earth (between the lines of Cancer and Capricorn), drew little attention until the late 20th century when the nexus between the carbon spewed into the environment by burning of fossil fuels and global climate disruption became impossible to ignore. Solar energy generation, long an object of scant scientific work, now has been vaulted into a central area of academic and industrial research.

Concentrated solar power (CSP) systems have been employed to capture usable solar energy. The CSP system comprises a large field of mirrors called heliostats arranged to receive and reflect focused sunlight onto one or more thermal receivers mounted at the top of a vertically tall power tower. The receivers comprise tube bundles through which a heat transfer fluid is circulated which is heated by the reflected solar energy from the heliostats. Molten salt has been used as the heat transfer fluid. The hot heat transfer fluid is used to directly or indirectly heat a working fluid such as water to produce steam for generating electricity, district heating, or industrial uses. Electricity if generated may be supplied to the electric power grid in large scale solar installations.

Improvements in renewable thermal energy systems which can effectively and efficiently utilize and store solar energy during the daytime for use any time of day upon demand are desired to reduce reliance on fossil fuels and concomitantly decrease greenhouse gas emissions which contribute to global warming.

### SUMMARY OF THE INVENTION

A renewable solar energy system is provided herein which supplants reliance on fossil fuels by providing efficient capture of the radiant solar heat energy incident on a solar collector and conversion of the captured heat energy into useful forms such as without limitation as an example high enthalpy steam (e.g., superheated steam) to produce electric power, or for industrial process or district heating applications as some non-limiting examples. In other embodiments, the solar energy system may be configured to produce hot water or saturated steam for industrial or other uses.

In one embodiment, the solar energy system comprises a solar collector which may be a concentrated solar power (CSP) system that is thermally and operably coupled to a power generation system in one embodiment for generating electricity via the steam-powered Rankine cycle. An intermediary thermal energy storage system fluidly coupled between the solar energy and power generation systems includes a so-called “green boiler” which in one embodiment may be formed by a vessel referred to herein as a thermal energy storage (TES) vessel.

The solar energy system circulates a heat transfer fluid through a first closed flow loop between one or more thermal receivers mounted on a power tower in a heliostat field and the TES vessel to transfer captured solar heat or thermal energy to a heat retention medium such as a thermal mass composition contained in the TES vessel which is operable to absorb and retain heat. The power generation system may be a steam power generation system in one embodiment which circulates a working fluid such as water in a second closed flow loop between the thermal energy storage vessel and a steam turbine-generator set operable to produce electric power in a conventional manner. The turbine-generator set (also referred to as a turbogenerator in the art for short) forms part of a Rankine steam to electric power generation cycle. The first and second flow loops and components fluidly connected thereto are fluidly isolated from each other.

Portions of the first and second closed flow loops inside and extending through the TES vessel are formed by a plurality of tube bundles each associated with one of a plurality of conjugate heat exchangers. The tube bundles convey the heat transfer fluid and working fluid through the thermal mass composition in the TES vessel. The heat transfer fluid heated by the by the solar collector of the CSP solar energy system heats the thermal mass composition. The thermal mass composition inside the TES vessel in turn renders its stored thermal energy when desired on demand to heat the working fluid (e.g., water in one embodiment) to produce superheated steam for power generation in the present embodiment. The steam flows in the second closed flow loop through the turbogenerator to generate electricity which can be supplied to the power grid. In other embodiments, steam (superheated or saturated) may be produced for other steam applications including district heating or industrial purposes. In yet other embodiments, hot water may be produced by the solar energy system and TES vessel for industrial or other purposes.

In one embodiment, the heat transfer fluid heated by solar energy circulating in the first closed flow loop of the solar energy system may be molten salt, which may be a eutectic salt mixture in one embodiment. Other suitable salts useful for thermal energy capture and transfer may be used. An alternative heat transfer fluid may be used in lieu of salt including suitable synthetic heat transfer oil such as for example without limitation DOWTHERM™ available from Dow Chemical Inc. Heat transfer oil can be especially useful for lower temperature applications, for example <400 Deg. C (heat transfer fluid temperature). The description presented herein in the context of molten salt for convenience of reference therefore also applies to synthetic heat transfer oil or other suitable heat transfer fluids useable in a CSP system.

The TES vessel of the thermal energy storage system may be a heavily-insulated vessel configured and operable to retain and store heat. The vessel may comprise a cylindrical or other shaped shell which defines a sidewall and an internal space or cavity that holds a “captive” inventory of a thermal mass composition. The thermal mass composition is formulated and operable to absorb and store high quantities of heat derived from the heat transfer fluid associated with the CSP solar energy portion of the plant system circulated through the bed via the first closed flow loop. Conversely, the bed then yields the stored heat energy on demand to the working fluid such as water of the power generation system which is converted from its liquid phase water to produce steam (e.g., superheated steam) for powering the steam turbine of the turbine-generator set. This allows the thermal mass composition to be heated during the day via solar energy and yield its energy anytime of the day including at night when the CSP solar energy is inactive. The term “captive” used above connotes that the thermal mass composition remains stationary inside and does not flow into or out of the TES vessel during normal operation of the system in contrast to the heat transfer fluid and working fluid which circulate through the bed via their respective closed flow loops and associated tube bundles powered by pumps, as further described herein.

In one embodiment, the internal cavity of the TES vessel is subdivided into a plurality of vertically elongated heat transfer cells by a partition structure disposed in the cavity. Each heat transfer cell is circumscribed by vertical cell walls of the partition structure which extend upwards from a bottom closure plate of the vessel. The walls thus define the upwardly open heat transfer cells each having a cross-sectional area configured to receive and house only a single conjugate heat exchanger in one embodiment. Each heat transfer cell in one embodiment is physically isolated from adjacent and all other cells by the cell walls to be independently operable with its heat exchanger. Each cell therefore contains a separate and individual inventory or volume of thermal mass composition which is isolated from the thermal mass composition in the other cells. There is no single contiguous mass or bed of thermal mass composition material that fills the internal cavity of the TES vessel. The heat transfer tubes and working fluid tubes of one of the conjugate heat exchanger are directly embedded in the discrete volume of thermal mass composition in each cell for a two-way exchange of heat into and from the composition. Each cell defines a separate and independently operable heat transfer zone in which heat is extracted by the thermal mass composition from the hot heat transfer fluid (e.g., molten salt or heat transfer oil) flowing in the first closed flow loop heated by solar energy to in turn heat the thermal mass composition, and the working fluid (e.g., water) flowing in the second closed flow loop to in turn extract heat from the thermal mass composition to heat the working fluid which changes phase from for example liquid water to steam. The working fluid therefore in one embodiment is a phase change fluid. It bears noting that the totality of the thermal mass collectively stored in the plurality of heat transfer cells of the TES vessel may be operated in parallel for a total combined output of the heated working fluid. In other embodiment as further described herein elsewhere, sets or clusters of heat transfer cells may be operated independently to yield working fluid at different phases (e.g., liquid or steam), temperatures, and pressures.

For a TES vessel that has a cylindrical outer shell, the most efficient use of the circular internal space or cavity of the TES vessel may be made by a partition structure in which the cells walls are arranged to form a polygonal cell such as hexagonal heat transfer cells in transverse cross section thereby forming a honeycomb interior of the TES vessel in one embodiment; each cell being of course isolated from adjacent cells. This advantageously allows a tightly packed arrangement of heat transfer cells to be made inside the vessel to optimize the heat transfer capabilities of the system reflected by the ability of the thermal mass composition to absorb and retain a maximum amount of solar derived heat energy in the TES vessel for a given diameter of the vessel. However, other shaped cells could be used which in part may be dependent upon the shape of the TES vessel walls including for example without limitation polygonal shapes other than hexagonal including rectangular cells (e.g., square with equal sides or two pairs of opposing sides with different lengths), triangular cells, octagonal cells, etc. or others including pie-shaped cells, circular cells, etc.

The physically isolated nature of the heat transfer cells each with an associated conjugate heat exchanger and individual discrete inventory of thermal mass composition provides numerous functional and operational benefits. Each cell with conjugate heat exchanger is independently operable as a discrete heat exchanger platform from the other heat transfer cells with conjugate heat exchangers.

With respect to maintenance for example, if tube leaks or other problems occur with one of the conjugate heat exchanger units, the cell with the damaged heat exchanger unit can be taken out of service via use and selection of appropriate valving in the first and second closed flow loops while the remaining heat transfer cells continue to operate thereby enhancing the reliability of TES vessel and overall heat exchange system to keep the generation plant running to generate electric power.

With respect to performance and operational flexibility, there may be times when the heating capacity provided by the TES vessel does not require all heat transfer cells to be in operation in order to produce sufficient superheated steam to power the Rankine cycle to generate electricity. The independently operable heat transfer cells with associated heat exchanger therein allows a number of heat transfer cells (e.g., group or cluster) fewer than the total available number in the TES vessel may advantageously be operated to meet the steam demand while the remaining module are in standby mode. In addition, a number of cells with conjugate heat exchangers greater than that required to meet the max steam demand of the Rankine can be installed so that a degree of redundancy is provided allowing the plant to operated at maximum capacity with one or more conjugate heat exchangers and heat transfer cells out of service. This allows the plant to continue operation in the event of failed conjugate heat exchangers.

The thermal mass composition in one non-limiting embodiment may comprise a high thermal capacity mixture of granular particles including a phase change material (PCM) in combination with one or more other metallic materials as further described herein; all of which have heat absorption properties operable to absorb and retain heat over a period of time. Both the PCM and metallic materials of the mixture may be in the form of solid granular particles at ambient temperatures when not heated by the thermal mass composition. The PCM material preferably has a lower melting temperature than the metallic materials in one embodiment such that PCM material melts when initially heated by the heat transfer fluid (e.g., molten salt or heat transfer oil) while the metallic materials remain in a solid particle state during operation of the TES vessel 130 at its normal heated operational temperature. In one embodiment, the thermal mass composition may be Feorite™ available from Holtec International of Camden, New Jersey.

In one embodiment, the thermal mass composition (e.g., Feorite™) may comprise a fine blend of granular particles including iron ore, high conductivity material such as steel powder, and a phase change material such as copper-alloy based eutectic alloy. When heated, the eutectic alloy completely melts into a liquid at a specific temperature (i.e. its melting temperature) while the granular particles of iron ore and steel remain solid at the heated normal operating temperature of the TES vessel 130. This allow the thermal mass composition to flow between the heat transfer fluid and working fluid tube bundles of each heat exchanger 500 to make direct conformal contact with the tubes of the bundles along with the small granular particles of iron and steel which are entrained in the liquid eutectic alloy. When cooled, the eutectic alloy will solidify again back into a solid. With its high conductivity and heat capacity, the Feorite™ material in the TES vessel serves as a massive repository of thermal energy.

In one embodiment, the partition structure in the TES vessel may be formed using a modular system comprising a plurality and array of self-supporting transportable heat transfer modules which can be shop fabricated, shipped to the plant installation site, and lowered into the internal cavity of the TES vessel for positioning on the bottom closure plate thereof. Each module has a hollow enclosed tubular structure comprising a plurality of the vertical cells walls intersecting at an angle and coupled together to form a fully enclosed heat transfer cell on the sides, and a single conjugate heat exchanger therein which is supported from the cell walls. A baseplate may optionally be fixedly coupled to a bottom end of the modules to structurally reinforce the module and further isolate the thermal mass composition inside the module. The modules may be hexagonal shaped in one embodiment and arranged that TES vessel to form a honeycomb array or pattern of heat transfer cells. The modules are arranged in abutting relationship to each other in which at least some of the cells walls of each module abutting engage cells walls of adjacent modules on the sides. Each module is a fully functional and prefabricated heat transfer subassembly. Once installed in the TES vessel, the modules are each filled with a discrete volume of the thermal mass composition to form a separately operable heat transfer cell, as further described herein.

According to one aspect of the present invention, a modular heat exchange system comprising the conjugate heat exchangers may be deployed in the TES vessel which combines fluidic portions of the first and second closed flow loops into each heat exchanger unit which are separately insertable into and removable from the vessel. Each heat exchanger comprises both a heat transfer fluid tube bundle and a working fluid tube bundle fluidly isolated from each other but combined in a self-supporting heat transfer module that can be inserted into the internal cavity of the TES vessel one at a time to gradually build the partition structure forming the heat transfer cells in one embodiment. The heat transfer fluid tube bundle performs the function of heating the thermal mass composition using solar energy. The working fluid tube bundle performs the function of extracting thermal energy from thermal mass composition to convert water in one embodiment to steam for power generation or other uses, or simply hot water industrial or other uses. A plurality of vertically oriented and elongated heat exchangers in one embodiment are installed and arranged in the TES vessel. The tubes of both the heat transfer fluid and working fluid tube bundles are in conformal direct contact with the thermal mass composition in the TES vessel.

The TES vessel of the solar power generation system allows solar energy derived from the CSP collector to be stored during periods of time when sunlight is available. Electric power can be generated concurrently during those times to meet the demands of the electric power grid, or at other times when the sun is not shining such as during the evening hours via extracting stored heat from the thermal mass composition in the TES vessel to heat the secondary working fluid (e.g., water) of the Rankine power generation system. This versatility also allows the solar power generation system to advantageously operate either continuously as a base load power generation unit, or intermittently as a peak load unit. The TES vessel accordingly acts as a thermal energy storage battery.

For peak load electric power generation, the TES vessel with heat exchangers associated with the working fluid is configured and functions to boil the feed water/feedwater to produce the high-pressure superheated steam needed for the Rankine power generation cycle to produce electric power “on demand” whenever the grid faces a deficit of electricity to meet current load demand. Thus, when the grid faces a power deficit, the solar power generation system disclosed herein can serve as a peaking power generation unit further replacing traditional smaller natural gas or diesel peak power generation units (often sited at large base load fossil generating plant sites) traditionally used for peak power during electric load swing periods of the power grid.

The term “closed flow loop” as used herein means that a fluid flow path is defined in which the fluid can flow in a recirculating manner through the main portions of the loop and does not preclude the provision of various fluid inputs and fluid outputs to/from the flow loop controlled via provision and operation of suitable valving.

To overcome the foregoing problems with photovoltaic energy conversion systems that utilize batteries to store electric power when not immediately fed into the power grid in real-time, it is proposed to replace the batteries with the foregoing TES vessel by utilizing electric heaters to convert the electric energy generated by the array of solar panes to either (1) heat the thermal mass composition in the TES vessel, or (2) heat the primary or heat transfer fluid which flows through the TES vessel. In one embodiment, a plurality of electric energy injector (EEI) units are provided which are fluidly coupled to the first closed flow loop associated with the CSP energy system. The EEI units may be disposed around peripheral regions of the TES vessel at the top of the vessel internal cavity between the partition structure which defines the heat transfer cells and the shell of the vessel. The units comprise tanks defining an internal cavity which receives conveys a volume of the heat transfer fluid therethrough via a third closed flow loop fluidly coupled to the first closed flow loop associated with the CSP energy system. The electric heaters in one non-limiting embodiment are in the form of a plurality of immersion heaters with heating elements immersed in the heat transfer fluid of each tank to electrically heat the heat transfer fluid, which is returned to the first closed flow loop to enter the TES vessel for supplemental heating of the thermal mass composition in the TES vessel. This auxiliary additional heat input in turn increases the temperature and enthalpy of the working fluid flowing through the TES vessel which advantageously improves the efficiency of the power generation cycle. The photovoltaic array can also direct the electricity produced to the electric power grid at times of high demand in lieu of heating the heat transfer fluid. When the demand drops for power on the grid, the PV array may revert in operation to supplementing the heat input to the heat transfer fluid (e.g., molten salt or heat transfer oil) by the CSP energy system. Grid power may also be used to supply electricity to the heaters in the EEI units when sunlight is not available to power the PV array especially during non-peak load demand periods of the power grid making it economically feasible to use grid power.

The present solar energy system in one embodiment therefore comprises the CSP system for direct capture of solar energy for heating a working fluid, an array of PV solar panels for capture and conversion of solar energy into electricity for supplemental heating of the working fluid (or direct transmission to the power grid), and the TES vessel (green boiler) for storing thermal energy derived from the CSP system and/or the PV solar panels via the EEI units. The combination of the CSP and PVs deployed together may be referred to herein as a Hybrid Solar Energy System.

### BRIEF DESCRIPTION OF THE DRAWINGS

The features of the exemplary embodiments of the present invention will be described with reference to the following drawings, where like elements are labeled similarly, and in which:

FIG. 1 is a schematic flow diagram of a solar power generation system according to the present disclosure which includes a solar energy system, power generation system, and thermal energy storage system;

FIG. 2 is a perspective view of one thermal receiver of the power tower;

FIG. 3 is a perspective view of a thermal energy storage (TES) vessel of the thermal energy storage system comprising a plurality of heat transfer cells and associated heat exchangers;

FIG. 4 is a perspective view thereof with a portion of the shell of the vessel cut away and removed to reveal the cell walls of the heat transfer cells inside;

FIG. 5 is a side view of the TES vessel;

FIG. 6 is a side cross-sectional view thereof;

FIG. 7 is an enlarged detail taken from FIG. 3 of the upper portion of the TES vessel;

FIG. 8 is an enlarged detail taken from FIG. 6 of the upper portion of the TES vessel;

FIG. 9 is a top view of the TES vessel with the top cover removed to show the internal cavity of the vessel with array of heat transfer cells and only the top portions of the heat exchangers in each cell (piping and manifold system with headers not shown);

FIG. 10 is a top view of only the array of heat transfer cells in the vessels but with full tube bundles of the heat exchangers in each cell shown;

FIG. 11 is a side perspective view of the heat transfer cells and cell walls of the TES vessel;

FIG. 12 is a side view thereof;

FIG. 13 is a first vertical cross-sectional view of the array of heat transfer cells and cell walls taken from FIG. 10;

FIG. 14 is an enlarged detail taken from FIG. 14;

FIG. 15 is a second vertical cross-sectional view of the array of heat transfer cells and cell walls taken from FIG. 10;

FIG. 16 is an enlarged detail taken from FIG. 15;

FIG. 17 is an enlarged perspective view of a top portion of one of the heat transfer cells of the TES vessel showing the heat exchanger support system and top header assembly of the heat exchanger;

FIG. 18 is an enlarged perspective view of a bottom portion of one of the heat transfer cells of the TES vessel showing the bottom header assembly of the heat exchanger;

FIG. 19 is a perspective view of one of the heat exchangers of the heat transfer cells showing the top and bottom header assemblies and the tube bundles;

FIG. 20 is an enlarged top detail taken from FIG. 19;

FIG. 21 is an enlarged bottom detail taken from FIG. 19;

FIG. 22 is a first side view of one of the heat exchangers;

FIG. 23 is a second side view thereof;

FIG. 24 is a top view thereof;

FIG. 25 is a bottom view thereof;

FIG. 26 is a first vertically split side thereof;

FIG. 27 is a second vertically split side view thereof;

FIG. 28 is a third vertically split side view thereof;

FIG. 29 is an enlarged detail taken from FIG. 26;

FIG. 30 is an enlarged detail taken from FIG. 28;

FIG. 31 is a top view of the tubesheet of the heat transfer fluid combined inlet-outlet header of one of the heat exchangers;

FIG. 32 is a side of the inlet-outlet header and tubesheet;

FIG. 33 is a top view of the tubesheet of the working fluid outlet header of one of the heat exchangers;

FIG. 34 is a side view thereof;

FIG. 35 is a perspective view of a self-supporting and transportable heat transfer module usable inside the TES vessel to form the array of heat transfer cells;

FIG. 36 is a side view of one of the heat transfer cells showing an alternate embodiment of a heat exchanger usable in the TES vessel.

All drawings are schematic and not necessarily to scale. Parts given a numerical reference designation in one figure may be considered to be the same parts where they appear in other figures without a numerical reference designation for brevity unless specifically labeled with a different part number and described herein. Any reference herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

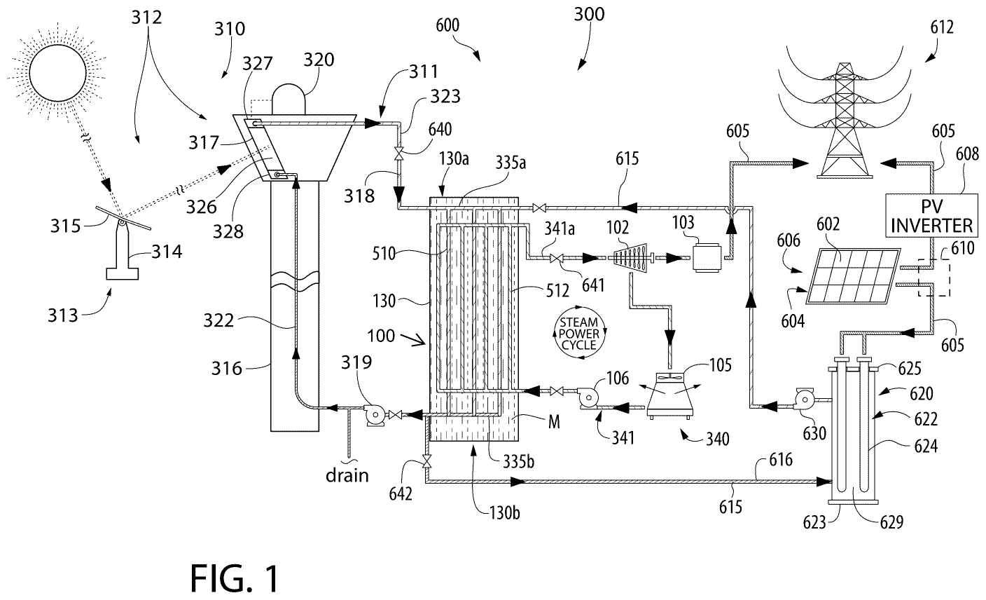

FIG. 1 is a schematic flow diagram of a solar power generation system according to one embodiment of the present disclosure which includes a solar energy system, power generation system, and thermal energy storage system. The generator system may include a Rankine steam power cycle which derives input energy from solar thermal energy capture in lieu of fossil fuels to generate the superheated steam necessary to produce electricity.

Conventional fossil-fueled boilers in Rankine systems which convert the boiler feedwater in a liquid state to high pressure steam are traditionally used for base electric load operation to satisfy the base load demand of the power grid since such boilers and associated auxiliary equipment cannot be quickly started for on-demand power generation. In fact, the entire startup process for fossil-fueled base load plants takes many hours (including up to a full day) to gradually bring all equipment and the system up to full pressure and temperature operating conditions necessary to reach full load without overheating the metal components of the system. By stark contrast, solar power generation system with TES vessel can be operated as either a baseload power generation plant, or for cyclical operation to supply peak power load demands on the power grid. Thereby offering significantly more flexible power generation capabilities.

The solar power generation system 300 in one embodiment generally includes solar energy system 310 comprising solar collector 312, power generation system 340 comprising a steam turbine 102 and electric generator 103, and thermal energy storage system 100 which operably and thermally couples the systems 310 and 340 together. Systems 310 and 340, however, are fluidly isolated from each other. As further described herein, the intermediary thermal energy storage system 100 comprises a “green boiler,” which in one embodiment may be formed by thermal energy storage (TES) vessel 130 containing a thermal mass composition M specially configured and operable to absorb heat energy and yield the heat energy on demand to produce steam for driving the power generation system 130.

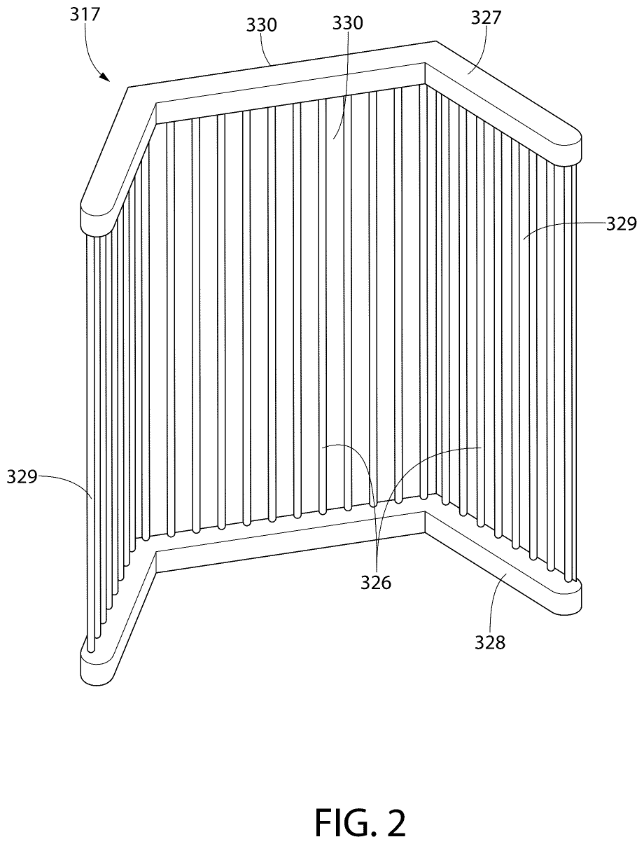

Solar energy system 310 is configured to circulate a heat transfer fluid in a first closed flow loop 311 between the solar collector 312 and the TES vessel 130 where the captured solar heat or thermal energy from the collector is used to heat to thermal mass composition M contained in the TES vessel. Flow conduits 318 form integral external portions of the first flow loop 311 to circulate the heat transfer fluid between solar collector 312 and TES vessel 130. In one embodiment, the flow conduits 318 may be formed by piping made of a material suitable for handling the temperatures, pressures, and chemistry of the heat transfer fluid. The flow conduits may be insulated and if necessary heat traced in some embodiments to minimize heat loss from the heat transfer fluid. The first closed flow loop 311 includes at least one recirculation pump 319 which provides the motive force to recirculate the heat transfer fluid through the first closed flow loop. Pump 319 may be located in first closed flow loop 311 upstream of the power tower 316 but downstream of TES vessel 130 as shown in FIG. 2.

The heat transfer fluid may be molten salt or synthetic heat transfer oil in some embodiments as previously described herein. Other suitable heat transfer working fluids however may be used if appropriate.

The solar collector 312 in one embodiment may be a concentrated solar power (CSP) collector which comprises a circular or semi-circular array of heliostats 313 mounted toward the top of the centrally-located power tower 316 (only one heliostat being shown in FIG. 1 for sake of brevity). Heliostats are commercially available in a wide range of sizes and curvatures from multiple suppliers. The power tower 316 receives thermal energy via sunlight focused on and delivered to the thermal receivers by the heliostats. Heliostats 313 each generally include a support frame 314 typically mounted on the ground (or another available support surface) and an adjustable reflector 315 configured to capture and reflect incident solar radiation or light. The reflectors may have any suitable configuration, and in one embodiment may each be formed by a concave mirror with radius of curvature set to focus solar energy incident on its surface onto at least one thermal receiver 317 mounted on the upper portion of the tall columnar power tower 316. In other embodiments, reflectors 315 may instead be formed by an assembly of multiple flat mirror panels arranged on the heliostat to form a faceted mirror construction which may be flat or slightly arcuately curved in shape. The sun's radiant energy (heat) is collected by the concave mirrors mounted on a drive mechanism that enables the mirrors to index and continuously face towards the sun as it traverses the sky through the day to optimize the amount of solar radiation captured. The receivers may be positioned at multiple elevations in a sufficiently tall power tower 316 so that radiant heat energy of the sun can be more effectively captured from a large heliostat field. The receivers 317 are integral fluidic parts of the first closed loop 311 which serve to convey the received thermal energy from the sun to the TES vessel 130 which in turn is interfaced with the power generation system 340. The receivers 317 are heat exchangers with heat exchange tubes as further described herein which serve as the entry point for the thermal energy input into the solar energy system, which heats the recirculating heat transfer fluid to a desired target temperature.

The CSP system disclosed herein may utilize an optimization algorithm that maximizes the total solar exposure to the array of heliostats on a given land area. This optimization formalism considers the plot size and latitude of the plant's location. The Heliostats' size and their spacing are available parameters that can be varied to arrive at the highest solar energy capture configuration. Calculations show that in the region between the line of Capricorn and the line of Cancer, daily Energy Capture Density (ECD) as high as 5 MWh per acre of heliostat-seeded land can be achieved. In more temperate regions of the earth, the ECD may be somewhat less, down to ˜4 MWh per acre.

The power tower 316 is a vertically elongated and tall metallic structure configured for mounting on the ground, such as on a suitable concrete foundation to which the bottom end of the tower may be bolted or otherwise secured. The tower may be cylindrical with a circular cross-sectional shape in one embodiment; however other suitably shaped structures including various polygonal shapes may be used. At least a portion of the interior of power tower 316 may be hollow to permit a “cold leg” fluid riser pipe 322 of the first closed flow loop to be routed internally in the support tube to/from the at least one or a plurality of thermal receivers 317 mounted at the top of the support tube. Although not shown in FIG. 1 for clarity, the “hot leg” 323 of the first closed flow loop may also be routed internally inside the tower. The internal routing of the riser pipe and hot leg inside the tower advantageously mitigates the effect of heat dissipaters such as wind and rain. Piping manifolds (not shown) of suitable configuration may be used in some embodiments to distribute the cold heat transfer fluid to each receiver provided, and in turn collect the heated heat transfer fluid from the receivers. It is well within the ambit of those skilled in the art to provide suitable flow distribution manifolds.

The terms “cold leg” and “hot leg” refer to the relative temperature of the heat transfer fluid (e.g., molten salt or heat transfer oil) after the fluid yields its heat to thermal mass composition M in the TES vessel 130 (cold leg) and enters the solar collector 312, and before the fluid yields its heat obtained from the solar collector 312 to the thermal mass composition, respectively.

Referring to FIG. 2, the plurality of thermal receivers 317, which form integral fluidic parts of the first closed flow loop 311, each comprise a plurality of heat exchange tubes 326 fluidly coupled between a top outlet header 327 and a bottom inlet header 328. The heat transfer fluid flows inside on the tube side of tubes 326 through the receivers between the headers. The inside surface of the half tubes may have micro-roughness patterns in the shape of cones to increase the heat transfer between the tube surface and the fluid flowing through the tubes. The headers can be configured to create multi-pass heat transfer fluid flow paths through the tube bundle, if necessary, to affect the required amount of heating of the heat transfer fluid.

In one embodiment, heat exchange tubes 326 of each receiver may be arranged in tube walls including a pair of end tube walls 329 obliquely angled with respect to each other, and an intermediate tube wall 330 therebetween which in turn is obliquely angled to the end tube walls. This arrangement gives each receiver 317 a generally (but not perfectly) C-shaped structure which forms an outwardly open cavity as shown in order to reduce the heat losses from the receivers to the ambient environment. In other embodiments, the receiver may have a semi-circular and arcuately curved arrangement of tubes.

In one embodiment, each thermal receiver 317 therefore is a curvilinear structure which emulates a plate-type heat exchanger. The heat transfer surface which absorbs solar radiation in one embodiment may be made of metal sheets of undulating profile welded to a thick flat plate insulated on its back surface. Each undulation in the sheet serves as an autonomous heat transfer space forming heat exchange tubes 326 with a cross section approximating a half-tube (e.g., semi-circular). The heat transfer fluid flows inside the “half-tubes” picking up the solar radiant heat deposited on its outward facing surface by the heliostats 313. The receiver tube surface facing the heliostat may be coated with a material that has high absorptivity in the solar wavelength range, but a low emissivity in the infrared wavelength range. The receivers 317 may be arranged in a circumferential array adjacent to each other to receive the reflected and concentrated solar energy or radiation (i.e. light) flux from the heliostats for a full 360 degrees of the solar field for low latitude areas of the world. For high latitudes, the receivers are designed to receive the concentrated radiation flux from the north side of the tower in the northern hemisphere and from the south side of the tower in the southern hemisphere. Accordingly, a number of variations are possible to adjust to and maximize the solar site conditions and location.

The power tower 316 may further include an expansion tank 320 situated above the thermal receivers 317 to accommodate changes in the density of the heat transfer fluid with temperature. Expansion tank 320 may be fluidly coupled to each receiver at a suitable fluid connection point, such as the top headers in one non-limiting embodiment. Other suitable fluid connection locations to the receivers may be used.

Referring back to FIG. 1, the power generation system 340 of the solar power generation system 300 may a Rankine steam power generation system generally including without limitation a conventional steam turbine-generator set including steam turbine 102, electric generator 103 mechanically coupled thereto and operably connected to the electric power grid, steam condenser 105 which condenses the steam into condensate, and boiler feedwater pump 106. These components (excluding the generator of course) form integral fluidic parts of the second closed flow loop 341 along with the heat exchange portion of the “green boiler” (i.e. TES vessel 130) which conveys the second working fluid therethrough to absorb heat from the thermal mass composition M to produce steam which runs the steam turbine-generator set to generate electricity. The generator produces electricity in a conventional manner via a stator and rotor assembly well known in the art. The feedwater pump 106 circulates the boiler feedwater through the second closed flow loop 341 formed in part by flow conduits 341a such as piping which fluidly couples the water bearing components of the Rankine cycle and TES vessel together as shown. With exception of the present green boiler, the remaining balance of plant components of the clean energy Rankine cycle necessary to form a complete power generation system may be provided and operate in the same foregoing and well known manner as traditional Rankine cycle components to produce electricity.

Depending on the installation site, the condenser 105 may be a conventional water-cooled condenser if a source of natural water (e.g., river, lake, etc.) is available or recirculated cooling water cooled by a natural draft cooling tower (e.g., hyperbolic) or fan-operated mechanical draft cooling towers. Alternatively, an air-cooled condenser (represented schematically in FIG. 1) may be used if no sufficient cooling water source is available to instead use ambient air to cool and condense the steam emitted from the steam turbine 102. Since many solar installation sites are in dry desert-type locations where there is an abundance of available sunlight throughout the year, an air-cooled condenser may more commonly be employed with the hybrid solar energy system disclosed herein but is not limited to use of such a condenser.)

It bears noting that the TES vessel 130 can generate steam with pressures up to about and including 3000 psi to meet a variety of steam power electric generation needs and applications. High-pressure superheated steam may be produced by the TES vessel to power the Rankine cycle power generation equipment.

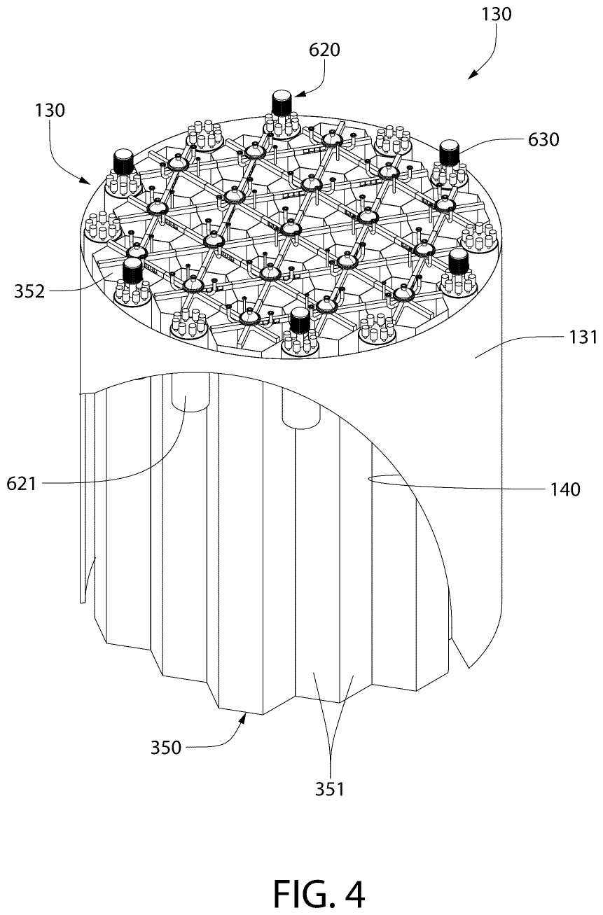

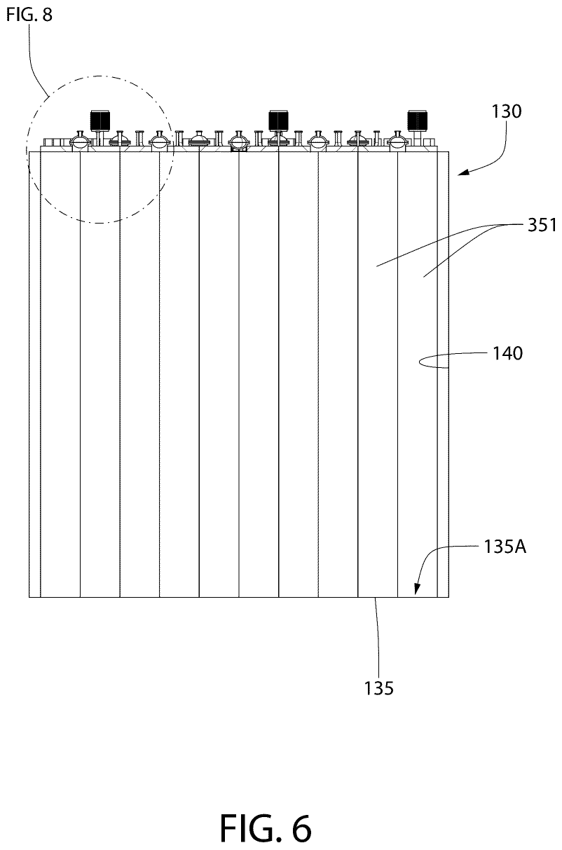

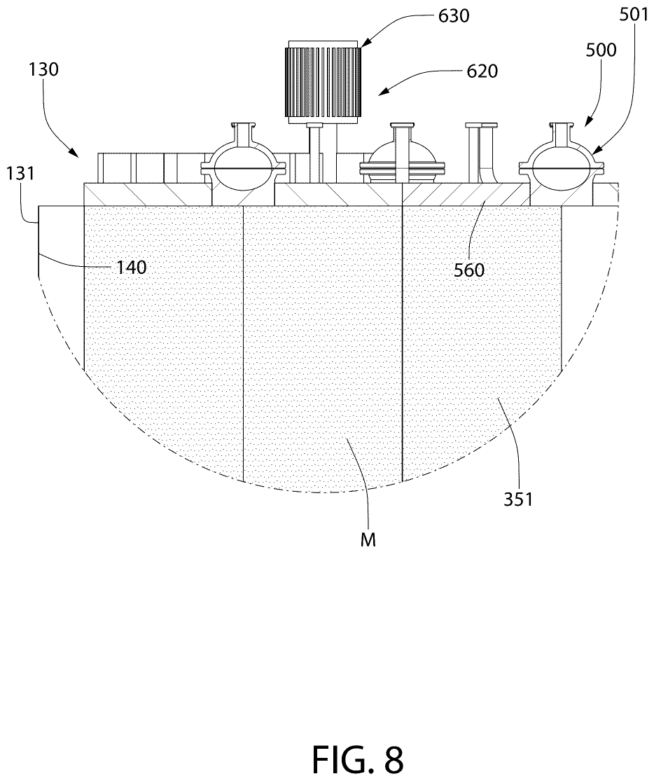

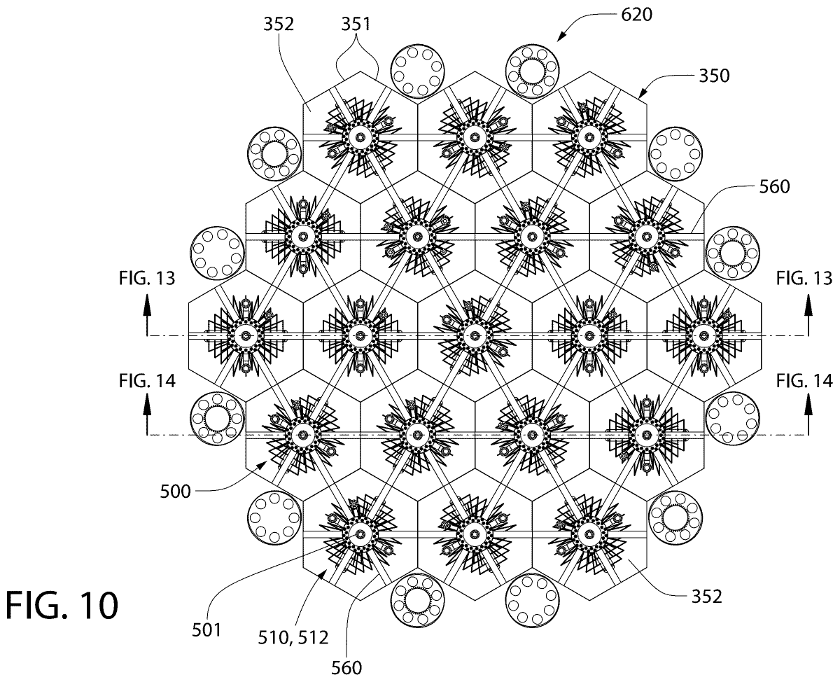

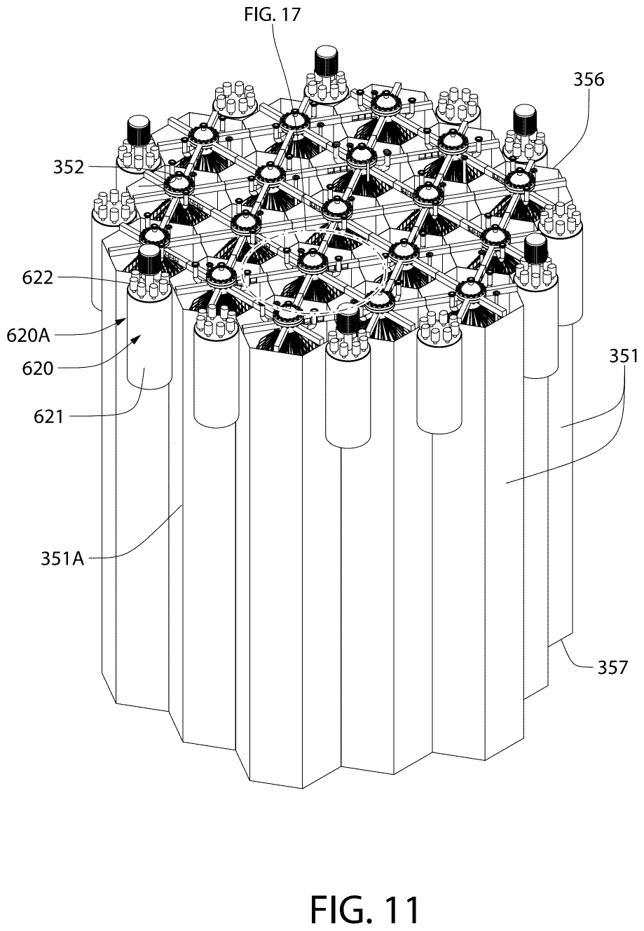

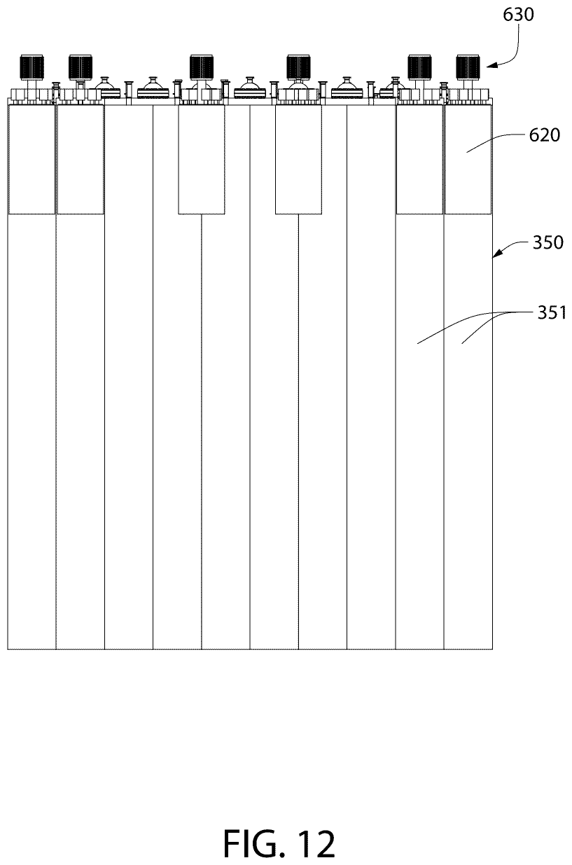

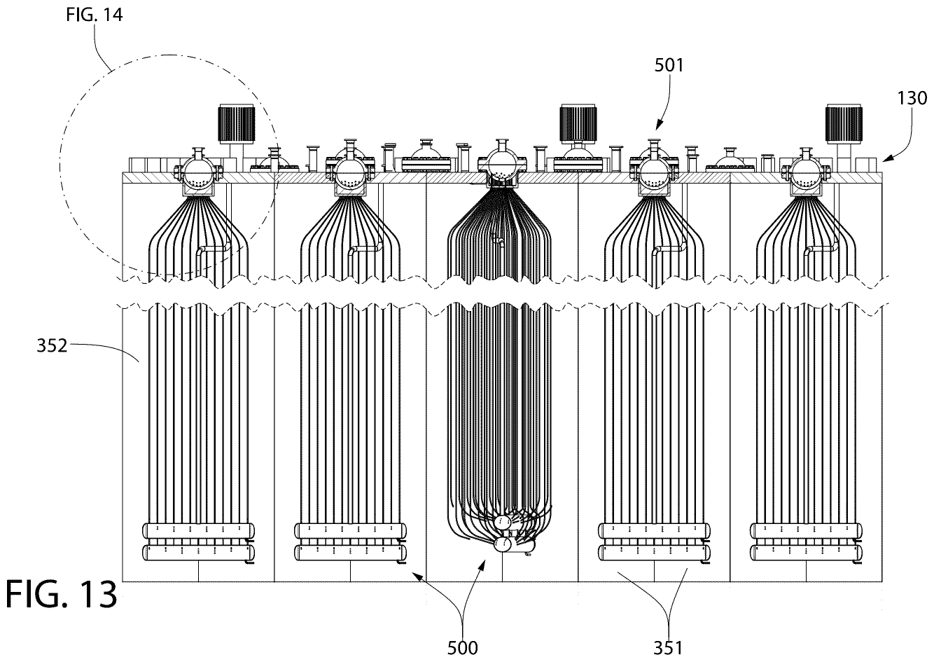

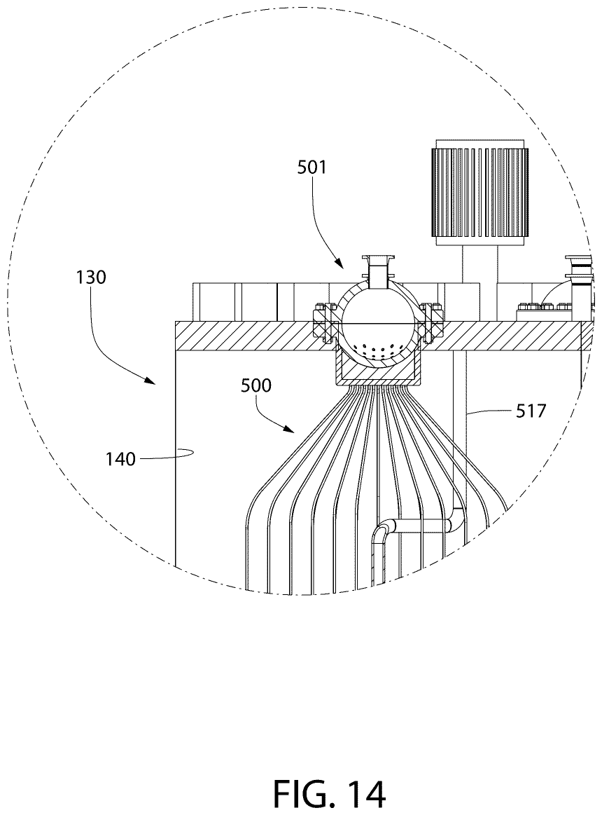

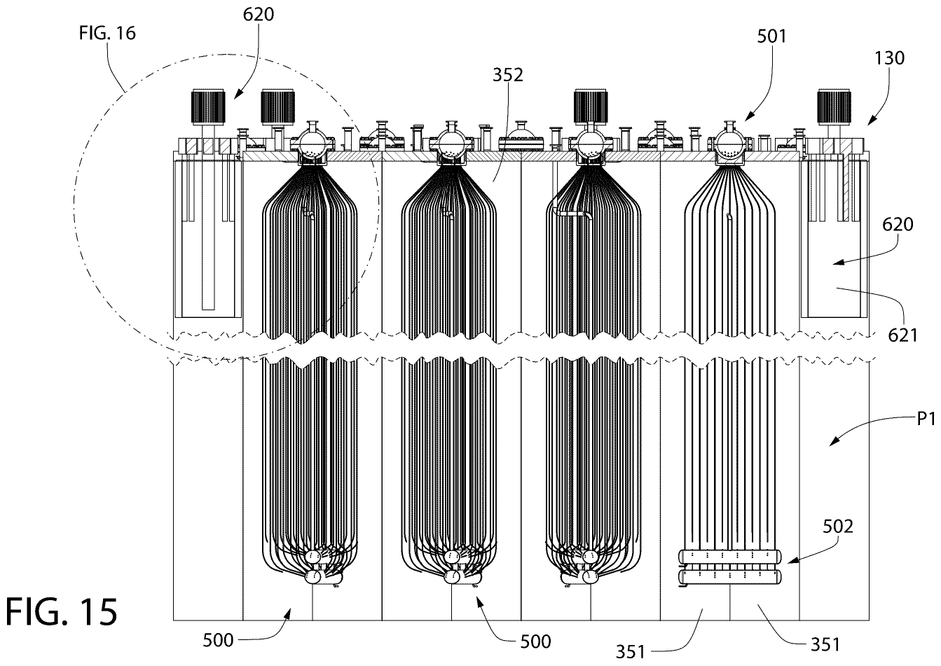

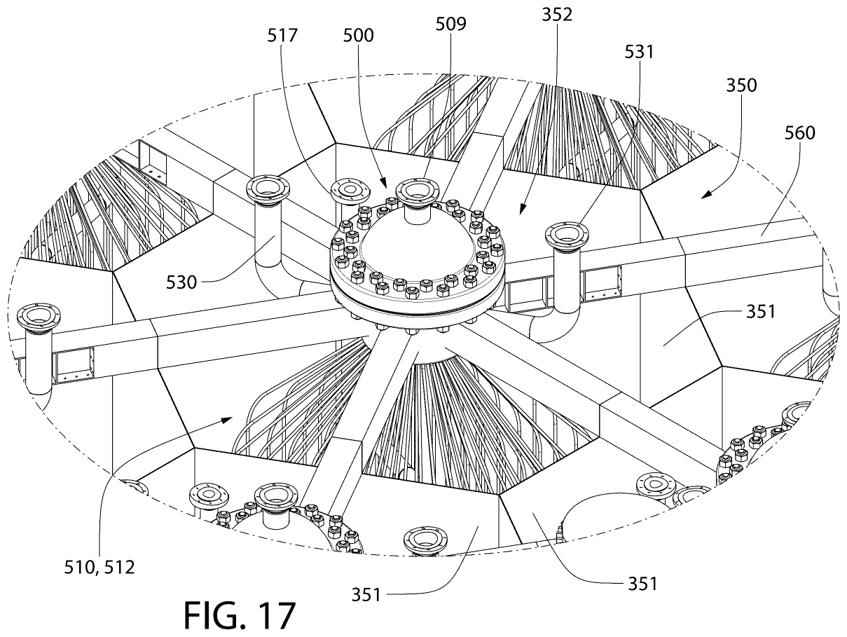

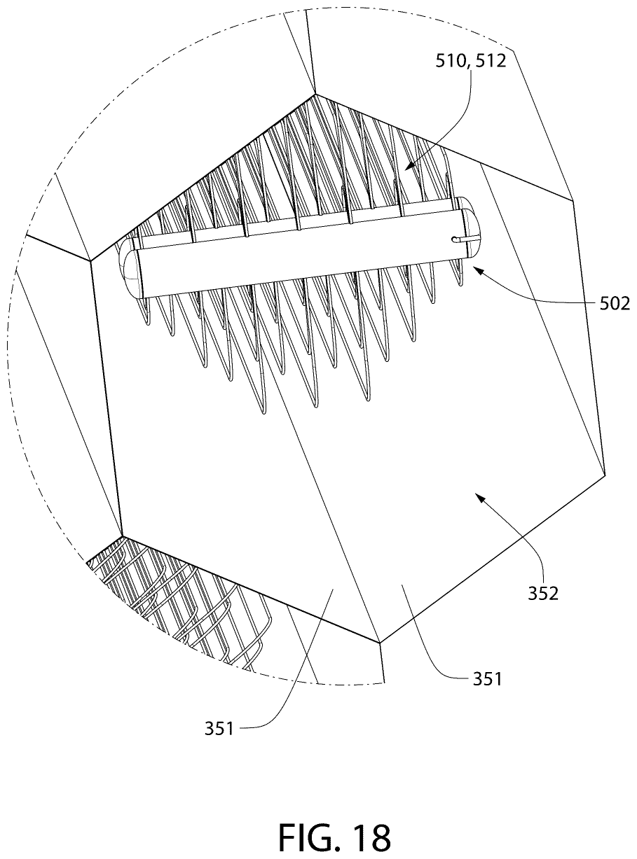

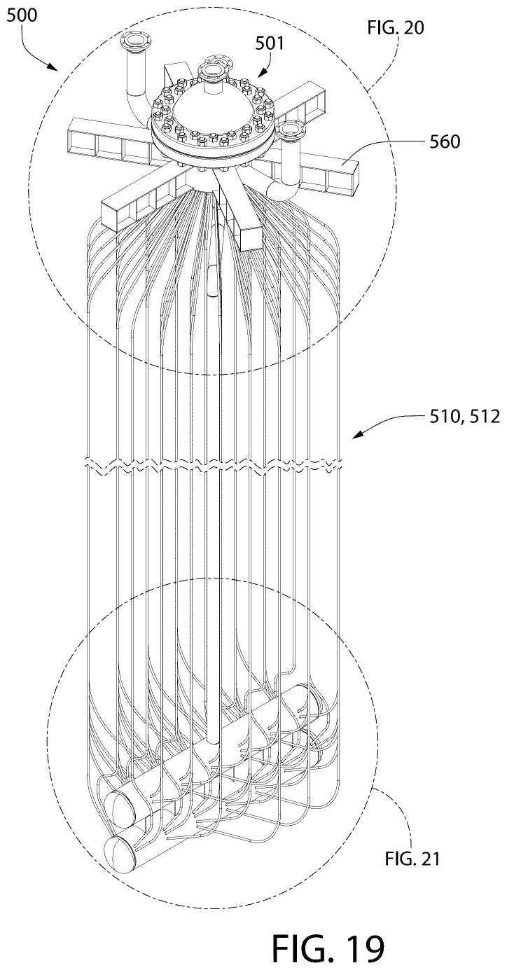

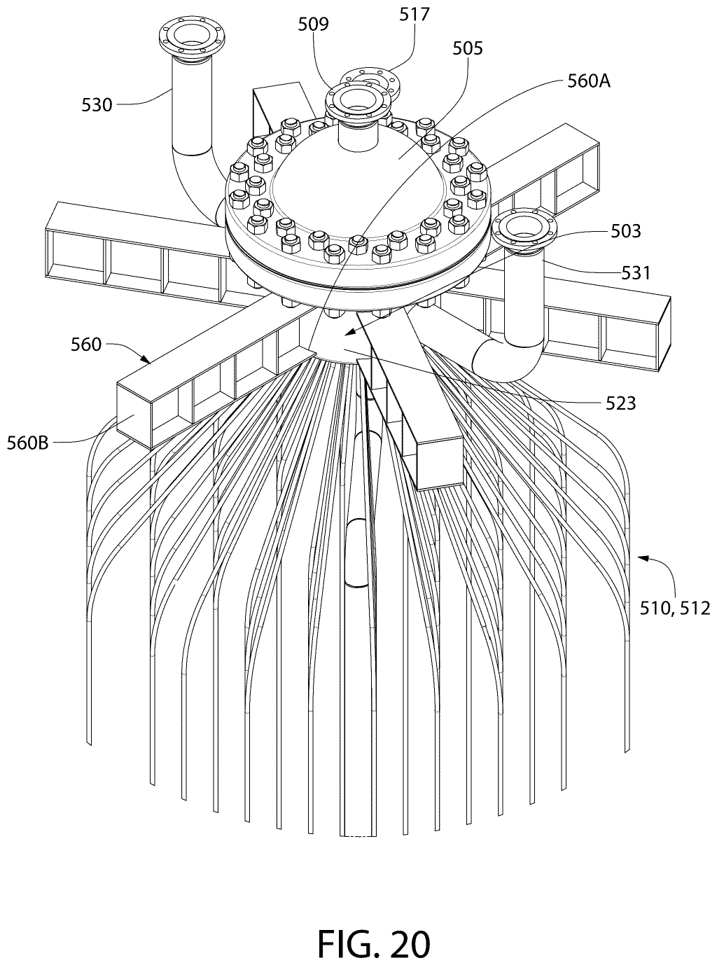

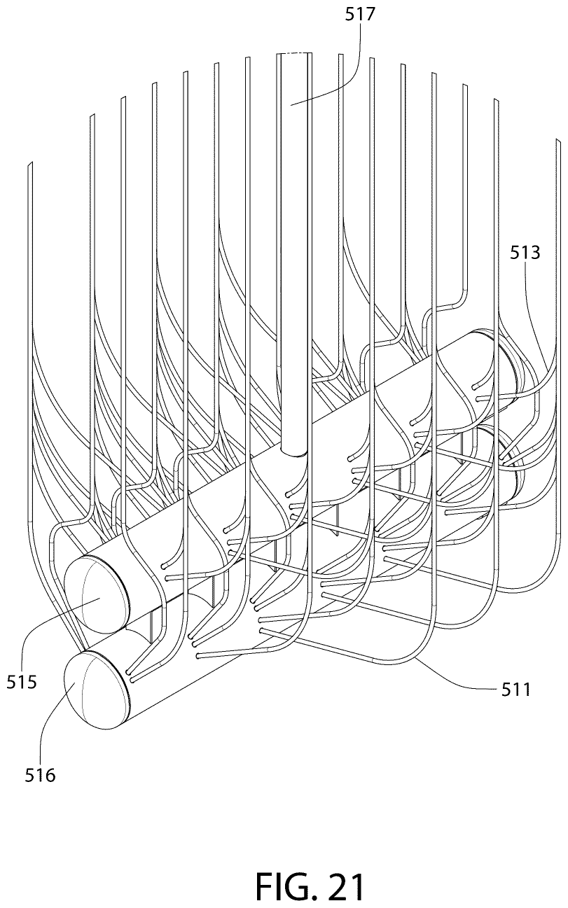

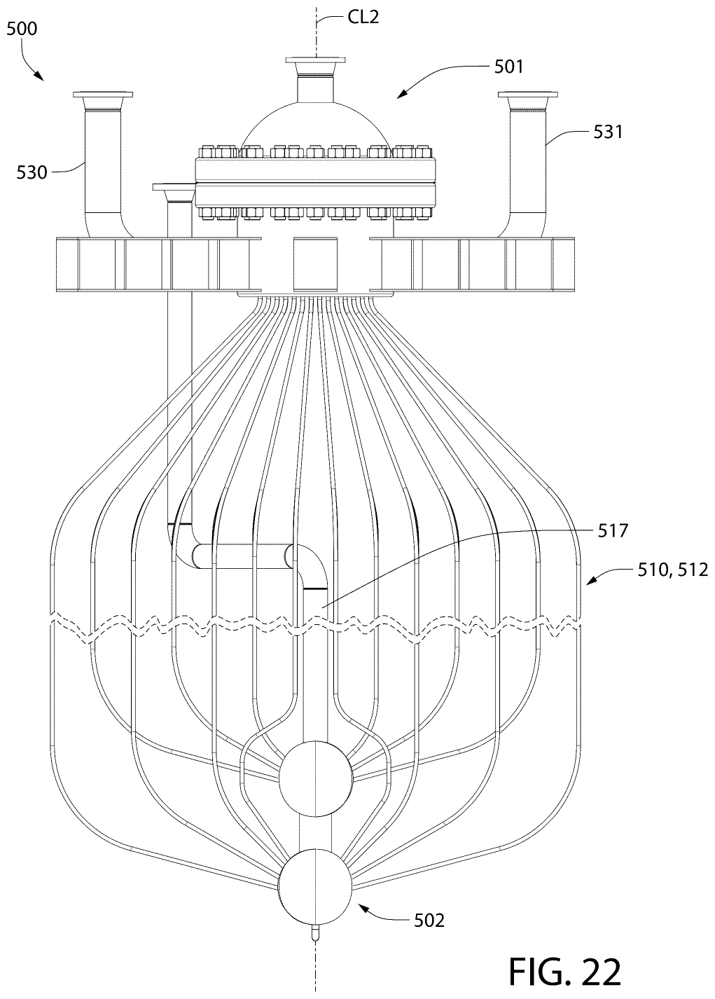

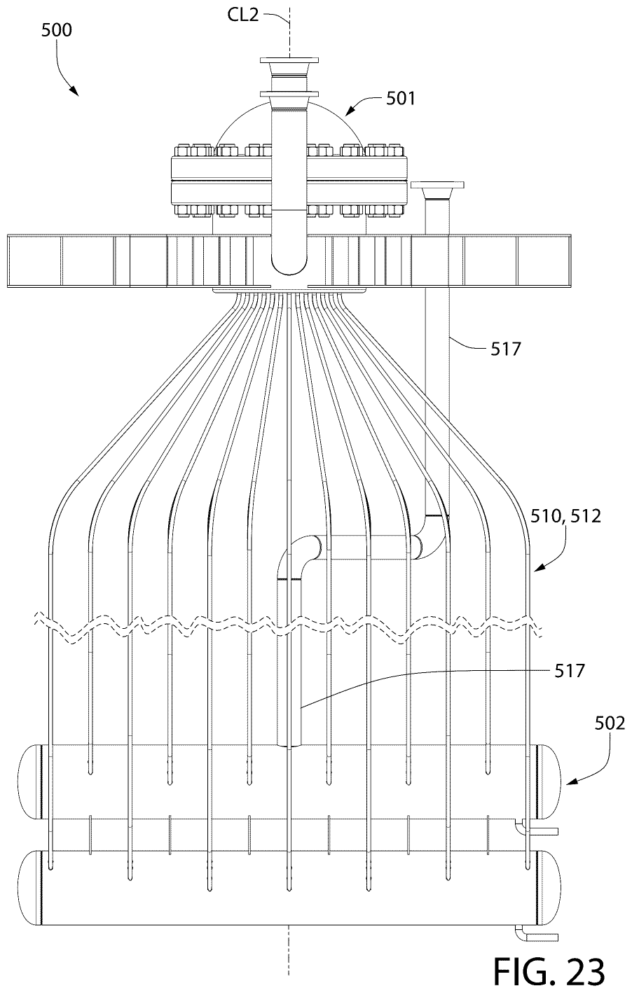

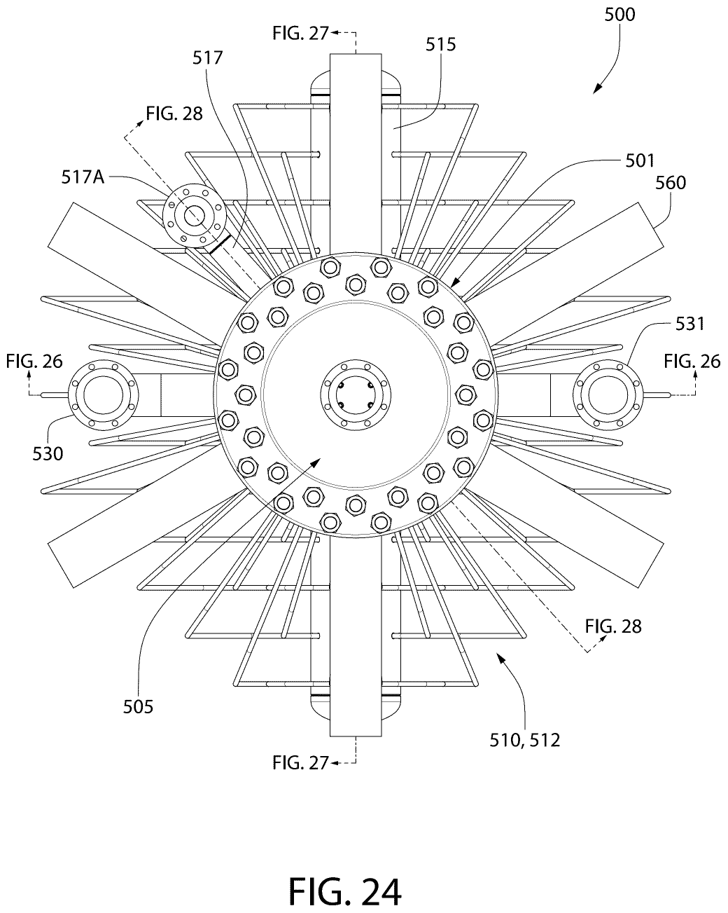

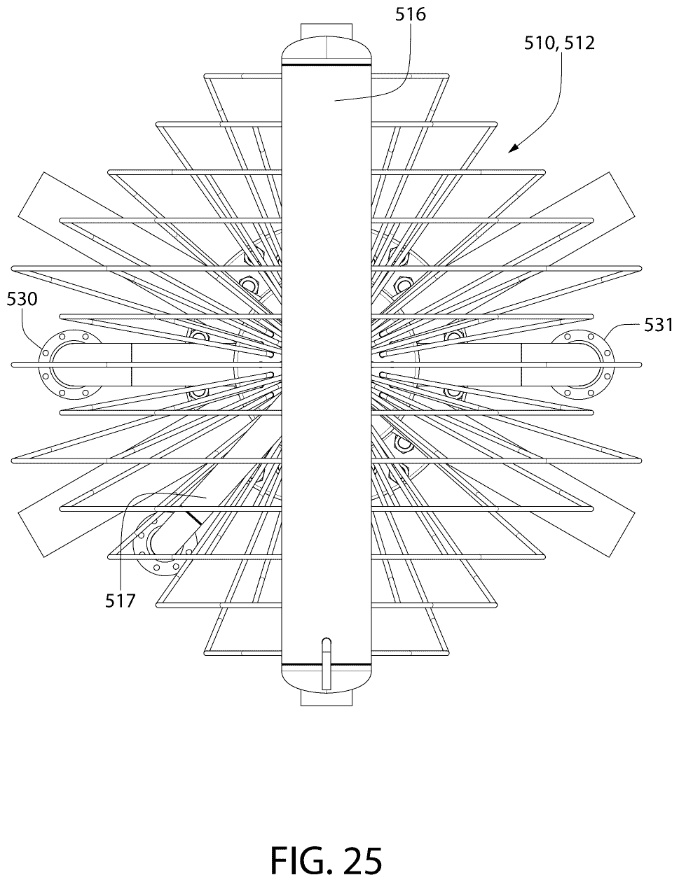

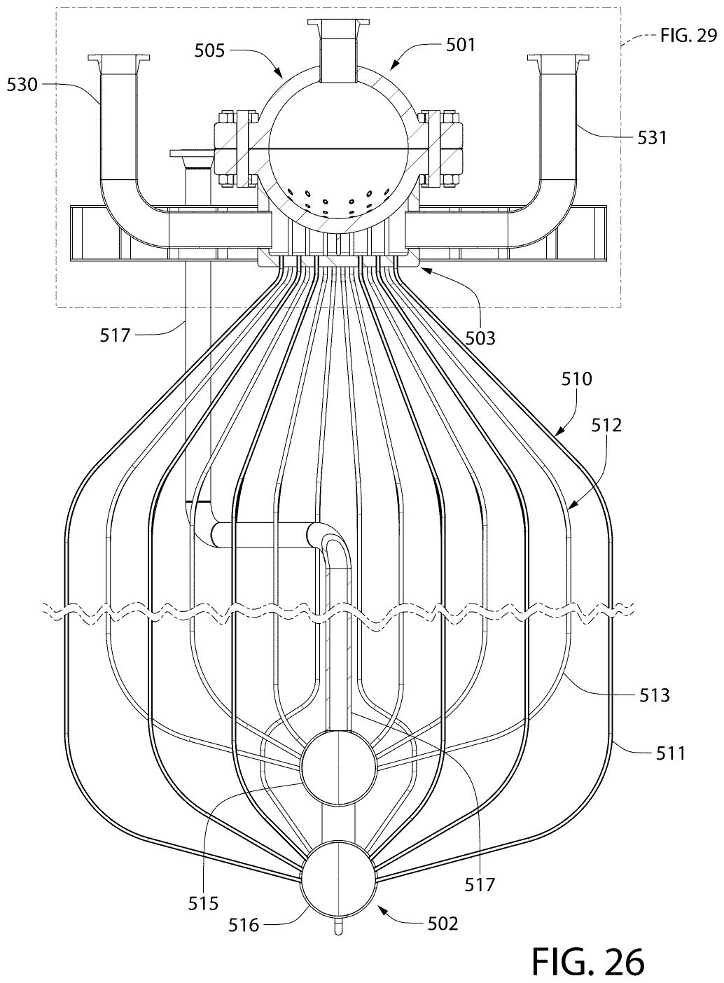

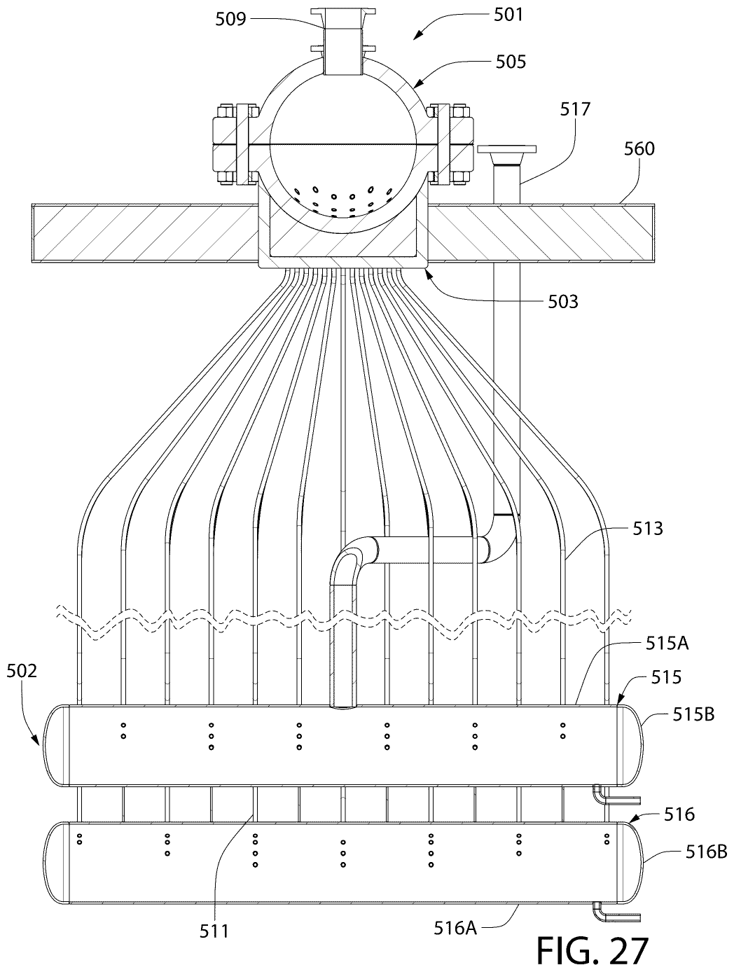

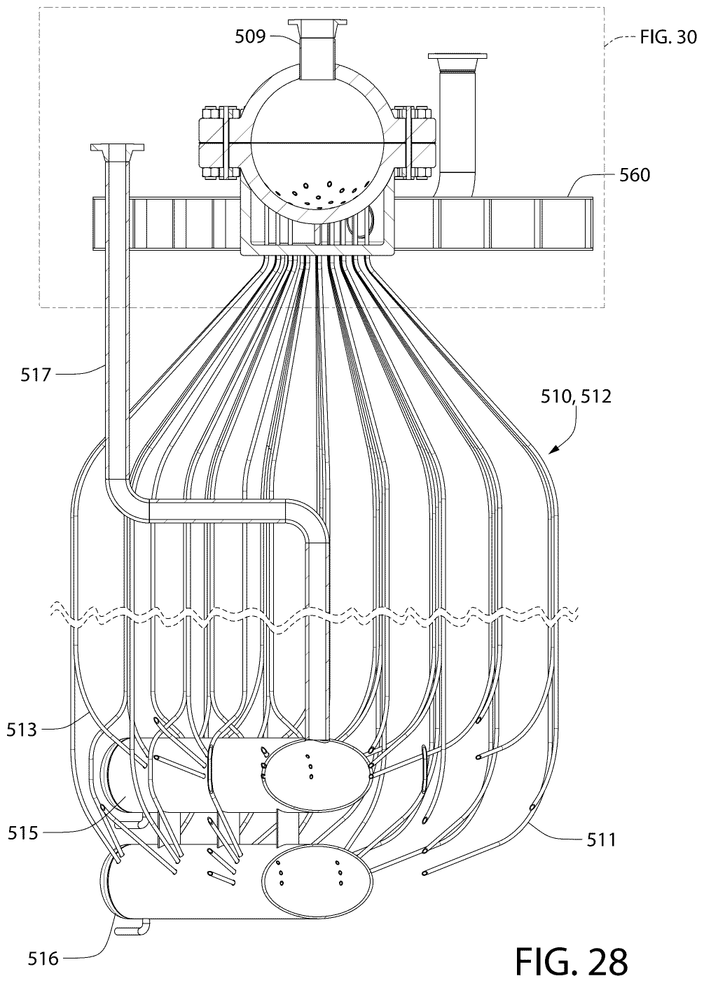

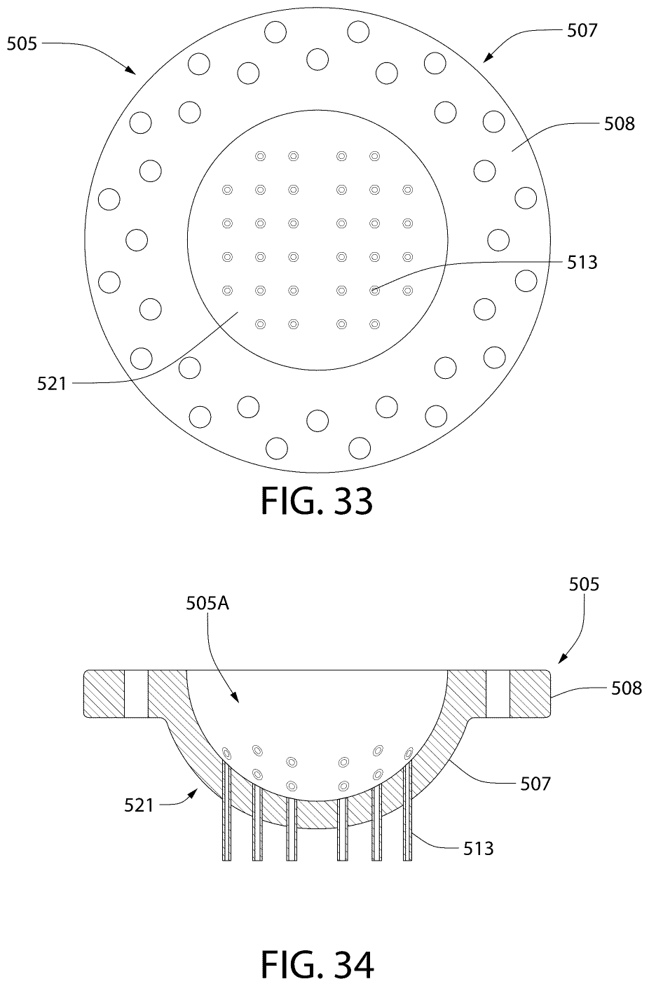

Referring generally to FIGS. 1-36 as applicable, the thermal energy storage system 100 as previously described herein comprises heavily insulated TES vessel 130. A plurality of conjugate heat exchangers 500 are disposed in the vessel. Each heat exchanger includes pluralities of fluidly isolated heat transfer fluid heat exchange tubes 511 and working fluid heat exchanger tubes 513 (thus the term “conjugate” representing the two different fluidly isolated tube bundles that each convey a different fluid in each heat exchanger). Heat exchange tubes 511 are integral fluidic parts of the first closed flow loop 311 associated with the solar energy system 310 which circulates the heat transfer fluid between the thermal receivers 317 and TES vessel 130. Heat exchange tubes 513 are integral fluid parts of the second closed flow loop 341 associated with the power generation system 340 which circulates the working fluid (e.g., water or other) through the TES vessel and Rankine cycle equipment including steam turbine 102.

TES vessel 130 is vertically oriented and hollow structure which may have a cylindrical configuration and construction in one embodiment as illustrated. TES vessels of other configurations may be used including those with rectangular cuboid shapes, hexagonal shapes, and others. The shape of the vessel does not limit the concepts or invention disclosed herein. In various embodiments, the vessel may be horizontally broader than high, or vice versa.

TES vessel 130 defines a vertical centerline axis CA which passes through the geometric center of the vessel from side to side. This axis defines a point of reference to facilitate description of other components of the vessel and relative orientations between components.

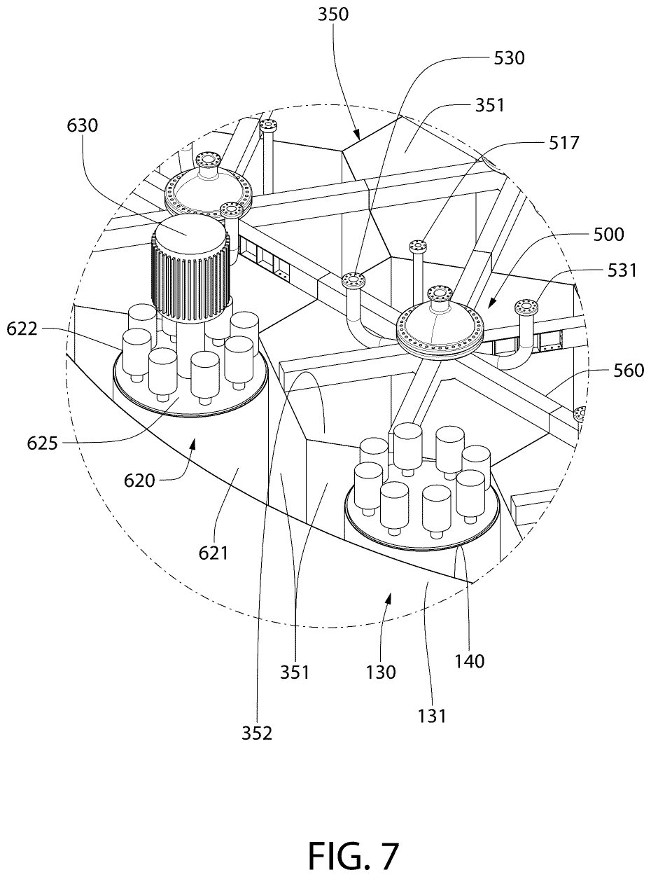

The TES vessel 130 generally comprises an enclosure which creates a leak-free storage tank. In one non-limiting embodiment, the TES vessel may comprise a metallic cylindrical outer shell 131 defining a vertical sidewall 134 extending along a vertical centerline axis CA of the vessel, a top end 132, and bottom end 133. In this configuration, TES vessel 130 has a circular cross-sectional shape. The shell 131 may be insulated in a typical manner used in the art for large industrial storage tanks used in the art such as via mounting an outer metallic jacket or cladding 141 on the exterior surface of the shell 131 in spaced apart relationship thereto and filling a gap formed therebetween with a suitable insulating material 142 such as mineral wool or another type insulation typically used for large heated storage tanks (see, e.g. detail provided in FIG. 7). Aluminum be used for the outer metallic cladding in some embodiments. Other insulation system used in the art may be used for insulating the TES vessel.

A bottom closure plate 135 is coupled to the bottom end 133 of the shell 131 in one embodiment by any suitable means (e.g., welding or other). Bottom closure plate 135 is configured and of suitable thickness for seating on and mounting to a suitable flat support surface such as one formed by a reinforced concrete base pad 137 located on the ground in one embodiment. In one embodiment, the bottom closure plate may be flat for such a mounting purpose. The closure prevent separates and prevents direct contact of the hot thermal mass composition M with the concrete base pad which could degrade the concrete over time. The bottom closure plate may comprise one or an assemblage of multiple joined metal plates welded together along their edges depending upon the diameter of the closure plate (collectively referred to herein as a “closure plate” even if an assemblage for convenience).

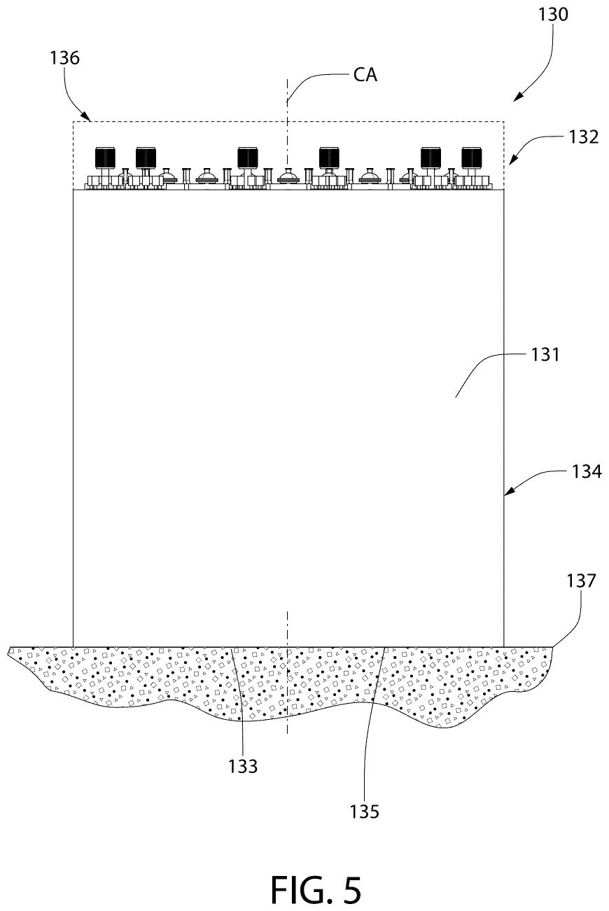

An insulated top cover 136 is coupled to top end 132 of TES vessel shell 131 by any suitable means (represented schematically by dashed lines in FIG. 5). The cover preferably encloses the otherwise open top area of the TES vessel 130 to both assist with heat retention in the vessel for thermal efficiency and protect the thermal mass composition and other equipment such as the heat exchangers 500 from the elements. Any suitable configuration and construction of a cover for these purposes may be provided. The cover preferably is structured to be removable in whole or parts to access the heat transfer cells 352 and heat exchangers 500 below for maintenance. The heat transfer fluid and working fluid piping headers and manifold system preferably are below the insulated cover for heat retention but are shown herein for clarity. It is well within the ambit of those skilled in the art to configured provide suitable manifold system with valving to distribute and collect heat transfer fluid and working fluid to/from the heat exchangers 500 in the TES vessel.

The TES vessel shell 131, bottom closure plate 135, and top cover 136 may be formed of a suitable metal such as steel. Corrosion resistant metals may be used such as stainless steel, carbon steel with a corrosion resistant epoxy or other coating material applied to its interior and exterior surfaces as necessary, or other materials. The metallic bottom closure plate 135 of the TES vessel 130 may be coupled and sealed to the bottom end of the shell 131 by any suitable means used in the art for forming a leak-proof enclosure such as via full circumferential seal welds in one embodiment. This prevent the ingress of water into the vessel 130 interior and retains the thermal mass composition with the interior cells.

For convenience of directional reference and description, TES vessel 130 defines a top 138 formed by top cover plate 136, bottom 139 formed by bottom closure plate 135, and sides formed by sidewall 134 of the shell 131.

The TES vessel 130 defines an open internal space or cavity 140 extending vertically between the top cover plate 136A and bottom closure plate 135 along vertical centerline axis CA of the vessel. Cavity 140 therefore extends for substantially the entire height of the vessel shell 131 excluding the thickness of these plates.

Internal cavity 140 of TES vessel 130 contains a plurality of individual heat transfer cells 352 further described herein which are each filled with a volume or inventory of a thermal mass composition M. The thermal mass composition is formulated and operable to absorb and retain heat from the hot heat transfer fluid circulated through a first tube bundle comprising heat exchange tubes 511 disposed in the vessel associated with the solar energy system 310 as further described herein. The thermal mass composition is contained separately within each heat transfer cell 352 in the vessel 130 in a “captive” state within the vessel meaning that the material does not actively flow into or out of TES vessel 130 during operation of the vessel. Only the heat transfer fluid (e.g., molten salt or heat transfer oil) and working fluid (e.g., water) flowing inside and through the tube-side of heat exchange tubes associated with each of the conjugate heat exchangers 500 actively circulate through the vessel to impart heat to or extract heat from the thermal mass composition respectively as further described herein.

The internal cavity 140 of TES vessel 130 in one non-limiting preferred embodiment may be subdivided into a plurality of the vertically extending and elongated open heat transfer cells 352 formed by a metallic partition structure 350 disposed in the cavity. The partition structure comprises a plurality of vertically extending and elongated cell walls 351. Each heat transfer cell in one embodiment is circumscribed by multiple angled vertical cell walls 351 of the partition structure which intersect along their vertical edges 351A at oblique angles in one embodiment for hexagonal cells. Each cell wall 351 includes a top end 356 and opposite bottom end 357 which define the top and bottom of each cell. Each cell wall may be flat in one embodiment.

In one embodiment, the cell walls 351 extend upwards from top surface 135A of the vessel bottom closure plate 135. Bottom ends 137 of the cells walls of each cell 352 abuttingly engage top surface 135A of bottom closure plate 135. In one embodiment, the bottom ends may be fixedly coupled to bottom closure plate 135 of the TES vessel such as via intermittent welds, a full seal weld extending around the entire perimeter of the cell, or 90 degree structural angle clips welded in turn to the lower portion of the cell walls along one horizontal edge and to the bottom closure plate of TES vessel 130 along the remaining horizontal edge. Other coupling methods may be used. Cells walls 351 and the cells 352 formed by the walls extend vertically upwards from the bottom closure plate for a majority of, and preferably substantially (i.e. 90% or more of) the entire height H1 of the TES vessel internal cavity 140.

The cells walls 351 of the heat transfer cells 352 in one embodiment may be abutted, fixedly coupled, sealed at their bottom ends 357 to the top surface 135A of the TES vessel bottom closure plate 135 to form a leak-proof seal therebetween. Seal welds may be used in one embodiment for this purpose. In other embodiments, the bottom ends of the cell walls may be abutted and fixedly coupled to but not completely sealed all the way around to the bottom closure plate. In yet other embodiments, however, the bottom ends of the cells walls 351 may abuttingly engage but not be fixedly coupled to the bottom closure plate if needed to allow for thermal expansion of the cells when the thermal mass composition M inside them is heated. The weight of the metal cell walls helps retain them in place on the bottom closure plate 135. Any of these foregoing constructions ensures that the thermal mass composition M inside each heat transfer cell 352 remains inside the cell and does not comingle with the thermal mass composition contained separately in other cells. The volume or inventory of thermal mass composition M inside each heat transfer cell is therefore physically isolated from the thermal mass composition of adjacent and all other heat transfer cells by the cell walls 351.

Accordingly, each heat transfer cell 352 with discrete isolated inventory of thermal mass composition and a single heat exchanger 500 therein and thermal isolation from adjacent cells is independently operable from the other heat transfer cells with heat exchangers thereby providing considerable operational and maintenance flexibility for the TES vessel 130. As previously noted herein, this advantageously provides the ability to operate select clusters or groups of heat transfer cells independently of the other cells or groups of cells. For example, the independently operable heat transfer cells 352 enables a working fluid such as water in one embodiment to be heated to multiple outlet conditions (phase, temperature, and pressure) in a single TES vessel 130 for different end uses or needs. By varying the flow of heated heat transfer fluid from the solar energy system to select sets or groups of cells 352 via configuration and operation of the heat transfer fluid header arrangement and valving, the heat input into the thermal mass composition of one set or group of cells via the heat transfer fluid tube bundle in each heat exchanger 500 can be controlled to provide more or less heat to certain cells which affects the phase and conditions (e.g., temperature and concomitantly pressure) to which the working fluid is heated in the cells.

In various embodiments, as a non-limiting example of the foregoing concept, a first set or group of heat transfer cells with a heat exchangers 500 in the TES vessel (less than the total number of cells) can be used to generate saturated steam for district heating or industrial purposes. A different second set or group of heat transfer cells 352 (less than the total number of cells) can produce heated water for district heating or other uses. And even a third set or group of heat transfer cells (less than the total number of cells) can generate superheated steam which behaves as an ideal gas for generating power via the Rankine cycle as described herein. The first, second, and third group of cells 352 can be operated simultaneously and in parallel if desired for any combination of the foregoing purposes and end uses. By selecting various combinations of valving and the header arrangement, working fluid with these different conditions and phases can be produced, directed, and conveyed to their intended end uses applications in parallel at the same time. The number of cells in each of the groups can be the same or different. The first, second, and third groups of cells if used may be clusters of adjacent cells in specific regions of the TES vessel 130, or can be spatially separated and distributed around the TES vessel depending on the working fluid outlet header and valve arrangement provided. It is well within the ambit of those skilled in the art to design and configure the outlet header and valving arrangement to meet the different working fluid outlet flow paths and end uses intended.

In view of the foregoing, it bears noting that the temperature of the thermal mass composition M in the plurality of the heat transfer cells 352 of the TES vessel 130 can therefore be substantially the same or different dependent upon the heat input into the cells and the degree of heating of the working fluid (e.g., temperature) intended. The minimum operating temperature of the thermal mass composition in the cells is preferably hot enough to keep the phase change material in a liquid state and the heat transfer fluid if molten salt in a liquid flowable condition. It further bears noting that the working fluid heated in the first, second, and/or third group of heat transfer cells 352 may be the same (e.g., water, oil, or another fluid), or a different working fluid can be heated in the first, second, and/or third group of cells. Accordingly, the TES vessel 130 can be operated to heat different types of fluids in a single vessel.

In one embodiment, the cell walls 351 of the partition structure are configured and arranged to form a plurality of hexagonal heat transfer cells 352 in the internal cavity 140 of TES vessel 130 (sec, e.g. FIG. 7). Hexagonal cells make efficient use of the available circular area and volume inside internal cavity 140 of a TES vessel having a cylindrical shape. For convenience of reference only, the vessel defines a pair of horizontal axes H1 and H2 in top plan view which intersect perpendicularly at the geometric center of the vessel at the vertical centerline axis CA as shown. The cells 352 are arranged in an adjacent manner in multiple staggered rows as shown. Accordingly, for example, cells 352 in one row R arranged and extending parallel to horizontal axis HA2 are staggered and horizontally offset from cells in adjacent rows on one side or another moving in the direction of the horizontal axis HAI so that there are no open spaces between the cells walls 351 of the tightly packed arrangement of cells. This advantageously maximizes the heat transfer and retention capacity of the TES vessel 130. A maximum number of heat transfer cells 352 are provided which can fit within the TES vessel internal cavity 140 for the diameter of the vessel used so that a majority of the area and volume within the vessel is occupied by heat transfer cells. As shown in FIG. 7, this forms open peripheral portions or regions P1 of the vessel 130 between the cells walls 351 of the cells 352 and the vessel shell 131 that extend perimetrically around the circumference of the vessel inside the internal cavity 140. In one embodiment, the peripheral regions Pl are not filled with thermal mass composition M but instead is an empty space and volume as these spaces are too small to fit conjugate heat exchangers 500 inside. Peripheral region P1 may be circumferentially contiguous in some embodiments as shown and is fluidly isolated from each of the heat transfer cells 352 forming a separate physically isolated volume extending perimetrically around the interior of the TES vessel.

Two construction approaches may be used for creating the internal partition structure 350 of the TES vessel 130. In a first approach described more immediately below, the partition structure may be formed by coupling together the vertical cells walls 351 onsite in portions or sections to erect the partition structure and form the heat transfer cells 352. The conjugate heat exchangers 500 can then be mounted in each cell after fabrication. The cells 352 are then each separately filled with an amount of the thermal mass composition M which fills the voids around the between the heat exchanger tube bundles 510, 512. This onsite or field erection approach to build the partition structure allows common cell walls to be used between some adjacent cells to create the intended cell shape as described below for efficiency and material cost savings.

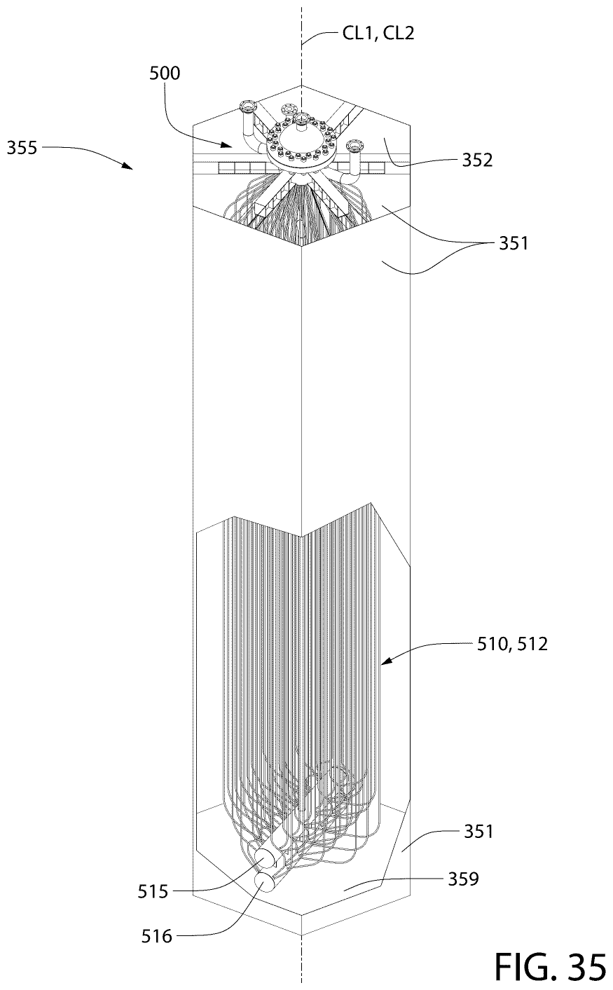

Alternatively, a complete heat transfer cell 352 which is a self-supporting transportable heat transfer module 355 of tubular structure can be shop fabricated which includes a plurality of the cells walls coupled together to form a fully enclosed cell on the sides (sec, e.g. FIG. 35). A single conjugate heat exchanger 500 may be mounted to the module in fabrication shop which is supported from the cell walls as a complete unit. Multiple heat transfer modules can be shipped to the plant installation site and mounted one-by-one in the internal cavity 140 of the TES vessel 130; each module being a fully functional and fabricated heat storage and exchange subassembly. The cells 352 are then each separately filled with an amount of the thermal mass composition M which fills the voids around the between the heat exchanger tube bundles 510, 512. Alternatively, the heat exchangers 500 can be instead mounted in the upwardly open heat transfer cells 352 defined by the modules after installation in the TES vessel 130. The modular approach is described later herein after the field erection approach discussed immediately below.

An efficient field erection construction technique for forming the partition structure 350 within the TES vessel internal cavity 140 may be obtained by using shared common cells walls 351C between adjacent heat transfer cells 352 where possible. As shown in FIG. 7, a single common wall 351C is located between internal portions of the cells 352 between adjacent cells to physically separate and isolate the cells, whereas peripheral cell walls 351B which face outwards towards the vessel shell 131 (e.g., sidewall 134) have no adjacent cells and therefore are not shared with other cells.

Since each cell 352 of the partition structure is independently operable as a heat storage and heat exchange unit, it is preferrable to both physically and thermally isolate each cell from adjacent cells to the greatest degree practicable. The cell walls 351 of the heat transfer cells 352 are preferably formed of a suitably strong metal but one which has a relatively lower thermal conductivity on the scale of metals to help insulate the thermal mass composition inside each cell from adjacent ones. Suitable metals having these properties are steel including carbon steel and stainless steel. Stainless steel in particular has a lower thermal conductivity than ordinary carbon steel and is a relatively good insulator. Stainless steel also offers corrosion protection from the thermal mass composition. Accordingly, preferred but non-limiting metallic materials used to construct cell walls 351 have a thermal conductivity less than 100 W/m-K (watts/meter-Kelvin) in SI units in some embodiments. Other metals such as titanium fall within this limit. Steel is considered a poor heat conductor in contrast to metals considered to be good conductors of heat such as copper and aluminum which have a thermal conductivity orders of magnitude greater than steel (e.g., greater than 200 W/m-K).

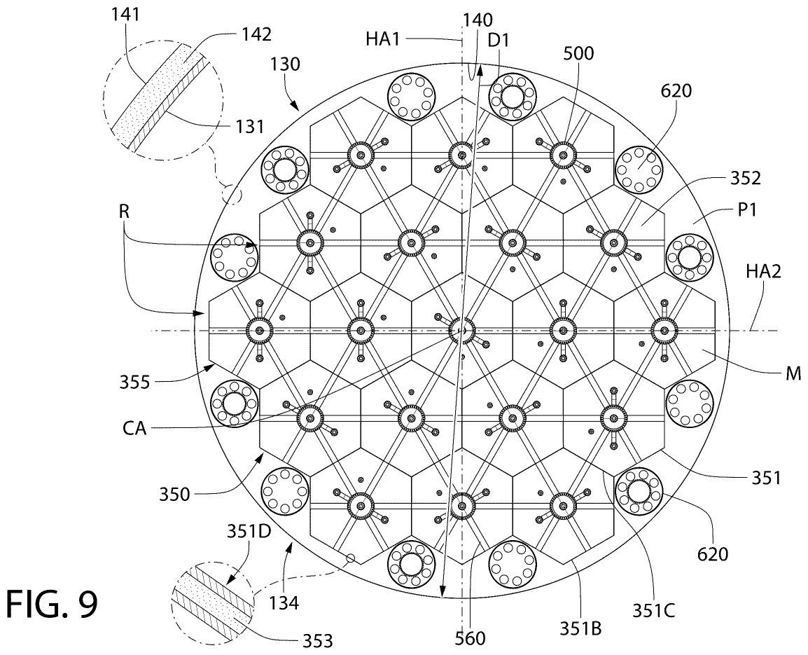

In some embodiments, the cells walls 351 whether shared or not between heat transfer cells 352 may be additionally insulated with suitable insulating material for the expected service conditions if required to further thermally isolate each cell 352 of the internal TES vessel partition structure 350. Ceramic fiber insulating materials such as K-Wool (Kaowool) rated for continuous use in temperatures up to 2200 degrees F. is just one example of a commercially available insulation product which may be used that is suitable for high temperature service conditions expected in an operating TES vessel 130 with heated thermal mass composition M. Other suitable insulating materials however may be used for the expected service conditions as appropriate. To protect the insulating material from direct contact with the thermal mass composition, each cell wall 351 in some embodiments may have a double-walled construction with the insulating material 353 being sandwiched between a pair of horizontally spaced apart cell sub-walls 351D as shown in the detail in FIG. 9. Alternatively, an air gap alone without an insulating material may be sandwiched between the sub-walls to provide an insulated cell wall 351. Advantageously, the insulated cell wall structure helps to minimize heat transfer between adjacent cells 352 so that each cell may be independently operated as a separate heat transfer module independently of all other cells, as further described herein. However, in other embodiments it is possible and may be acceptable to use uninsulated cell walls. The invention is expressly not limited to either insulated or uninsulated cell walls.

It bears noting that “thermally isolating” each heat transfer cell 352 from all other heat transfer cells should not be construed in its absolute sense to mean that no heat transfer whatsoever occurs between cells which cannot be achieved in a practical sense. Rather, the amount of heat that may migrate between cells is of such a minimal amount that it has no significant effect on the ability to operate each heat transfer cell independently of the others and maintain different temperatures of the thermal mass composition inside each cell which achieves the required thermal isolation for purposes of the present invention described herein.

Each heat transfer cell 352 contains a single conjugate heat exchanger 500 which in conjunction with the thermal mass composition M contained therein forms an independently operable heat transfer zone. This advantageously provides considerable operational flexibility since only some of the cells may be needed at various times to supply enough steam to power the steam turbine 102 and generate electricity to meet the power demands of the electric grid. In addition, modules in which heat exchangers develop tube leaks or other problems during operation of the TES vessel 130 can be fluidly isolated and taken out of service via closing appropriate valving thereby allowing the vessel to continue operation with the remaining modules.

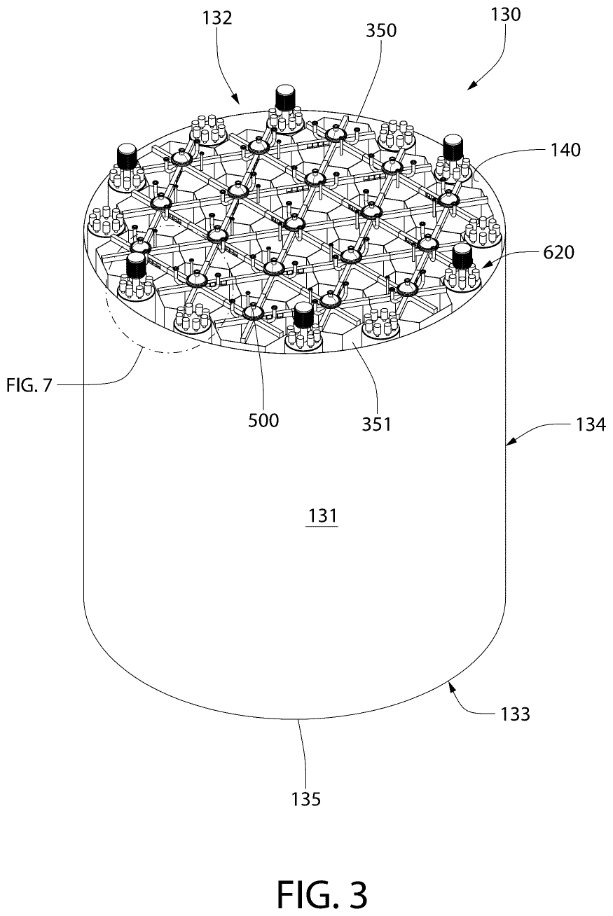

The conjugate heat exchangers 500 will now be described in further detail. With initial general reference to FIGS. 3-35, each heat exchanger 500 is disposed in a separate heat transfer cell 352 having a transverse cross-sectional area configured to hold only a single heat exchanger. The heat exchangers are vertically elongated and oriented when mounted in each cell of the TES vessel and heat transfer cells 352. The heat exchangers are centered within and extend along the vertical centerline CL1 of each heat transfer cell. Accordingly, the vertical centerline CL1 of each cell extends through and is coaxial with the vertical centerline CL2 of each heat exchanger 500.

Heat exchangers 500 are dual tube side flow heat exchangers each meaning that each includes a first heat transfer fluid tube bundle 510 configured to flow and circulate the heat transfer fluid heated by the solar energy system 310 through the inventory of thermal mass composition M in the discrete cell, and a second working fluid tube bundle 512 configured to flow and circulate a working fluid through the thermal mass composition in the discrete cell. Each tube bundle contains a plurality of heat exchanger tubes. For clarity of depiction to avoid unduly cluttering the drawing, it bears noting that the schematic system flow diagram of FIG. 1 shows a single heat transfer fluid tube bundle 510 and working fluid tube bundle 512 which is intended to collectively represent all of the tube bundles associated with all of the plurality of heat exchangers 500 installed in the TES vessel 130.

The tubes 511 of heat transfer fluid tube bundle 510 receive hot heat transfer fluid (e.g., molten salt or heat transfer oil) heated by the solar collector 312 which in turn heats the thermal mass composition via transfer of thermal heat to the composition. By contrast, the tubes 513 of working fluid tube bundle 512 receive the working fluid which may be water in a liquid state that undergoes a phase change to leave the tubes in a vaporous state such as superheated steam at the top. Accordingly, the water changes phase as it is heated by absorbing from the thermal mass composition. In one embodiment, the tube side flow of working fluid is in a vertically upwards direction which is most efficient since as the liquid water changes phase, the density decreases assisting in the rise of the water through the tube. Steam is collected in the steam dome at top of each heat exchanger 500 defined by the working fluid outlet plenum 505A formed in working fluid outlet header 505 as further described herein. Flow of the heat transfer fluid on the tube side of heat transfer fluid tube bundle 510 is in a vertically downward counterflow direction to the working fluid (albert the two fluids streams are never in contact with each other even through the tube walls).

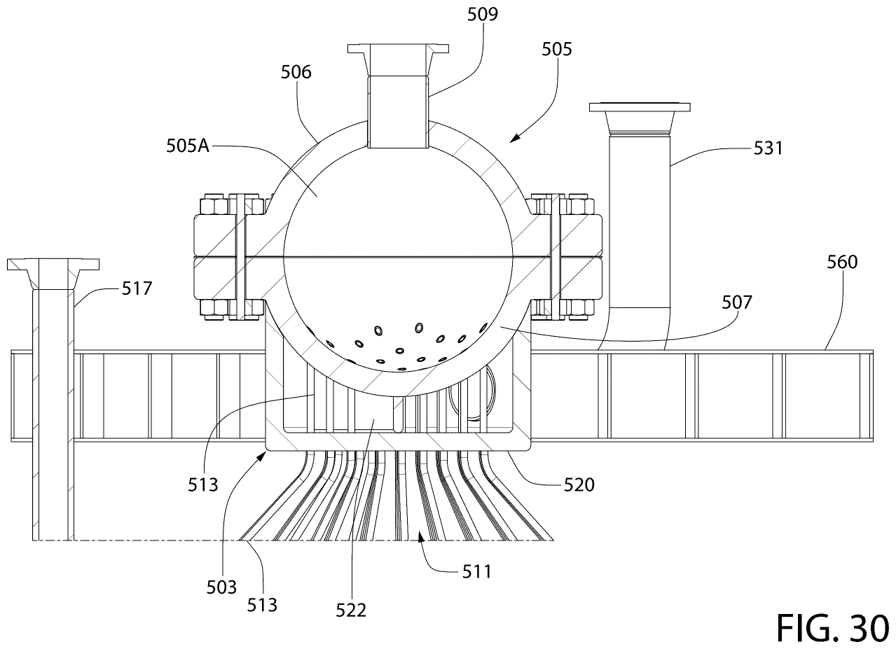

Tubes 511 and 513 are vertically elongated and interspersed amongst themselves in horizontally/laterally spaced apart but tight relationship creating open areas therebetween filled by the granular thermal mass composition which is in direct conformal contact with exterior surfaces of the tubes (see, e.g. FIG. 30 showing layout and pitch of tubes). The tubes 511, 513 are therefore bare and exposed directly to the thermal mass contained in each heat transfer cell 352. Because the thermal mass composition is in a granular particulate form, the material readily fills the relatively tight spaces formed between the tubes 511, 513 which may have a pitch separated by only two tube diameters in some embodiments. A majority of the length of the tubes in each tube bundle 510 and 512 may be straight in the intermediate portion of the bundles. Portions of the tubes adjacent to the upper and lower terminal ends of the tubes may be curved for fluid coupling and attachment to each of the various heat transfer fluid and working fluid heat exchanger headers as further described herein.

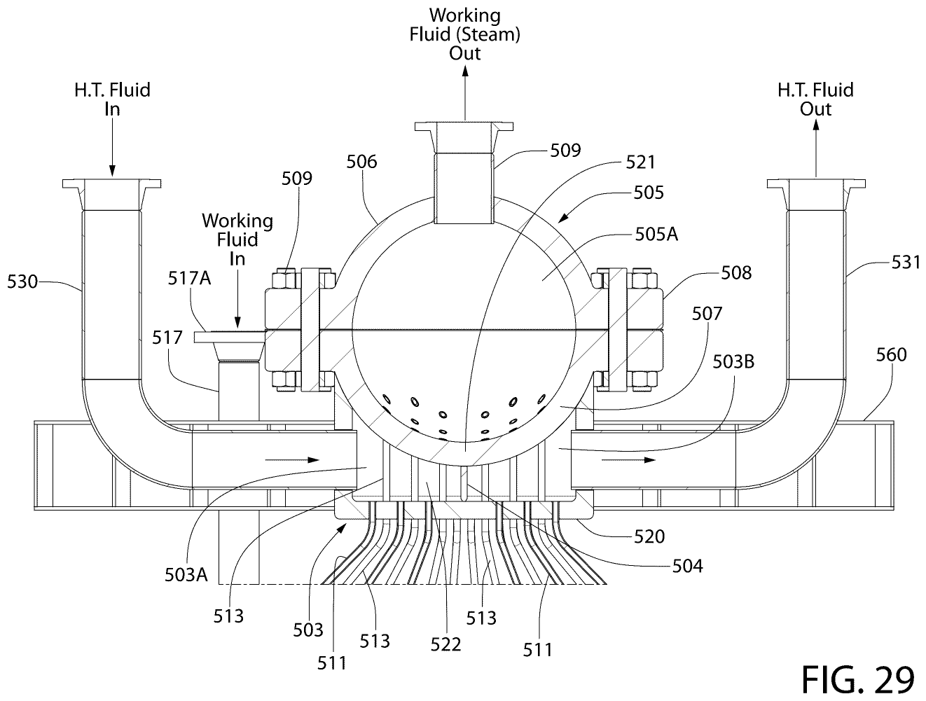

Each conjugate heat exchanger 500 generally includes a top head formed by a top header assembly 501 disposed adjacent to the top end of each heat transfer cell 352 to allow access to the heat exchanger, a bottom header assembly 502 disposed near the bottom end of each cell which is inaccessible, and intermingled tube bundles 510, 512 extending therebetween. In one embodiment, the top header assembly 501 may be a vertically stacked header assembly including a first heat transfer fluid combined inlet-outlet header 503, and an adjacent second working fluid outlet header 505 (see, e.g. FIGS. 29-30). Headers 503 and 505 are in direct physical contact and coupled together with the latter being disposed above the former header as shown. In one embodiment, the top header assembly 501 may be disposed above the thermal mass composition M to provide ready access for maintenance without requiring removal of the composition from the heat transfer cell 532.

On the heat transfer fluid side, the combined inlet-outlet header 503 includes an internal heat transfer fluid plenum 522 which is divided by partition plate 504 into an inlet plenum 503A on one side of the plate and outlet plenum 503B on the other side fluidly isolated from the inlet plenum (see, e.g. FIG. 29). On the working fluid side, outlet header 505 defines a working fluid outlet plenum 505A. Although headers 503 and 505 are physically coupled together, plenum 505A is fluidly isolated from plenums 503A, 503B.

The lower heat transfer fluid combined inlet-outlet header 503 of the heat exchanger top header assembly includes heat transfer fluid tubesheet 520 to which top ends of the heat transfer tubes 511 of tube bundle 510 are fixedly coupled. The upper working fluid header 505 includes a second working fluid tubesheet 521 to which top ends of working fluid tubes 513 of the tube bundle 512 are fixedly coupled. Any suitable tube to tubesheet coupling methods used in the art may be employed to form a leak-proof joint between the ends of tubes 511, 513 and tubesheets including for example without limitation hydraulic tube expansion, mechanical tube expansion, explosive tube expansion, and/or welding.

As shown, the heat transfer fluid and working fluid tubesheets 520 and 521 are vertically spaced apart which defines the heat transfer fluid plenum 522 therebetween. In one embodiment as shown, the lower tubesheet 520 defines a floor of plenum 522 whereas the upper tubesheet 521 defines a ceiling of the plenum 522. In one embodiment, tubesheet 520 may be circular in shape and flat. The heat transfer fluid combined inlet-outlet header 503 may have a cylindrical shape formed by a circular sidewall 523 in one embodiment. Heat transfer fluid tubesheet 520 is coupled to the bottom end of sidewall 523 via a circumferential seal weld extending around the perimeter of the tubesheet. Heat transfer fluid inlet piping 530 is fluidly and physically coupled directly to the inlet plenum 503A of heat transfer fluid combined inlet-outlet header 503 via inlet port 530A in the header sidewall 523. Heat transfer fluid outlet piping 531 is fluidly and physically coupled directly to the outlet plenum 503B of header 503 via outlet port 531A in header sidewall 523 diametrically opposite the inlet pipe 530. The coupling may be accomplished via welded or flanged and bolted connections. Both the heat transfer fluid inlet and outlet piping may have any suitable diameter and configuration necessary to efficiently fluidly couple the piping to the first closed flow loop 311 of the solar energy system 310.

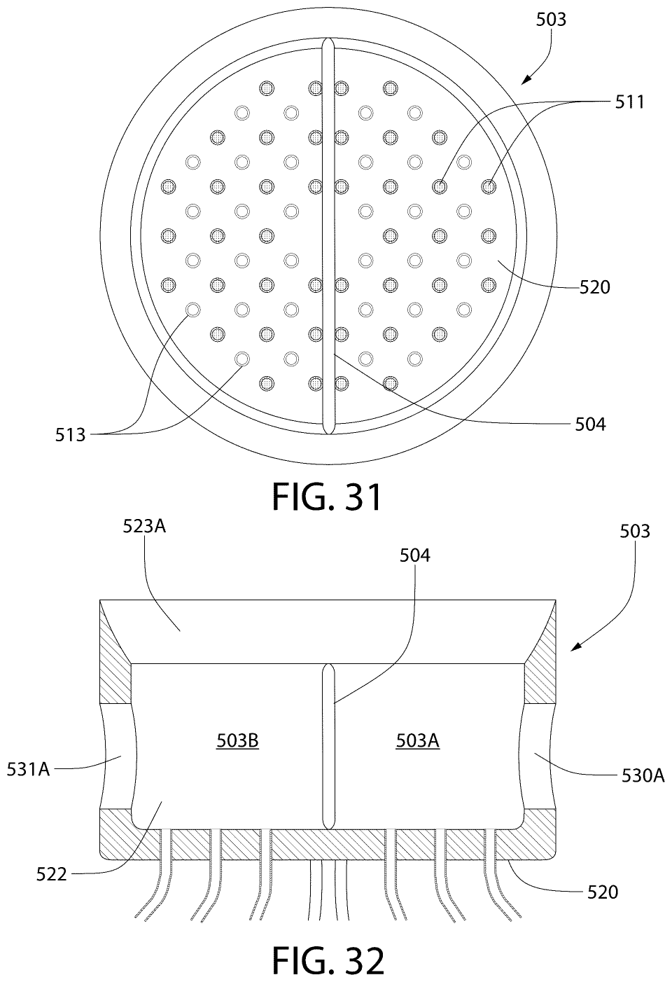

Working fluid outlet header 505 may be spherical in configuration or shape in one embodiment concomitantly giving tubesheet 521 a convexly and arcuately curved shape which forms part of the bottom half 507 of the header. Tubesheet 521 is welded to the heat transfer fluid combined inlet-outlet header 503. Specifically, a 360 degree circumferential seal weld may be used to weld the convexly curved tubesheet 521 to the top end of the circular sidewall 523 of the heat transfer fluid combined inlet-outlet header 503. This forms a leak-proof coupling to fluidly seal the internal heat transfer fluid plenum 522 of heat transfer fluid combined inlet-outlet header 503 at top. A portion of the convexly curved tubesheet 521 protrudes downwards into the internal heat transfer fluid plenum 522 of the heat transfer fluid combined inlet-outlet header 503. To receive the convexly curved tubesheet 521, sidewall 523 may be terminated at top with an annular angled seating surface 523A which is complementary configured to curved surface of the tubesheet (see, e.g. FIG. 31). A curved-to-curved interface is formed between the tubesheet 521 and header sidewall 523.

The top half 506 of the working fluid outlet header 505 is arcuately curved forming the steam dome which collects steam exiting the tops of tubes 513 of the working fluid tube bundle 512. A centrally located working fluid (e.g., steam) outlet nozzle 509 penetrates the center of the steam dome as shown to convey the steam to the steam turbine via the second closed flow loop 341 of the power generation system 340 (see, e.g. FIG. 1).

In one embodiment, the top half 506 of the working fluid outlet header 505 may be detachably coupled to its bottom half 507 such as via a gasketed flanged and bolted connection. Each half of the header comprises an annular flange 508 coupled together via a plurality of threaded bolts 509. This advantageously allows top half 506 to be uncoupled from the bottom half 507 which is welded to the heat transfer fluid combined inlet-outlet header 503 as previously described herein, thereby providing ready access to tubesheet 521 formed by the lower portion of the bottom half to facilitate plugging leaking working fluid tubes 513 of the working fluid tube bundle 512 or other maintenance/inspection reasons. In other embodiments however, the top and bottom halves of working fluid outlet header 505 could be welded together to form a leak proof working fluid outlet plenum 505A therein.

The bottom header assembly 502 of each conjugate heat exchanger 500 includes a working fluid inlet header 515 and heat transfer fluid return header 516. The headers may not be physically coupled together in some embodiments so that they can thermally expand in length at different rates due to the temperature differences of the inlet working fluid and heat transfer fluid encountered. The headers 515, 516 are therefore not physically restrained so that they may grow thermally without introducing thermal expansion cracking. In one embodiment, the headers are vertically spaced apart as shown one above the other. Heat transfer fluid return header 516 may be located below working fluid inlet header 515 since the heat transfer fluid tube bundle 510 is a two-pass flow tube bundle in the non-limiting illustrated embodiment which provides greater space for the inlet and outlet heat transfer fluid tubes 511 to be coupled to header 515. By contrast, the working fluid tube bundle 512 is a single-pass flow tube bundle with a lesser number of tubes which can be more readily interspersed between the tubes of the heat transfer fluid tube bundle 510. Other header and tube bundle arrangements may be used in other embodiments.

In the non-limiting illustrated embodiment shown, headers 515, 516 may be horizontally elongated hollow cylindrical structures which can be formed of section of piping of suitable diameter for the flowrate encountered. Each header 515, 516 comprises a cylindrical tubular body 515A, 516A capped at each end by a head 515B, 516B welded thereto to form a leak proof pressure vessel. In various embodiments, the type of heads used may be hemispherical, ellipsoidal (semi-elliptical), torispherical (flanged and dished), or flat heads depending on the expected pressures of the heat transfer fluid and working fluid; hemispherical heads being suitable for high pressure applications, flat heads being suitable for lower pressure applications, and other head types falling therebetween. Since the pressures and temperature of the heat transfer fluid and working fluid may be different, different types of heads may be used for the working fluid inlet header 515 compared to the heat transfer fluid return header 516 (i.e. not the same head type need be used for each header). The working fluid inlet header 515 and heat transfer fluid return header 516 may have the same length in some embodiments to produce a horizontally compact tube bundle which collectively includes the heat transfer fluid and working fluid tube bundles 510, 512.

A working fluid inlet downcomer 517 receives cooled working fluid such as boiler feedwater from the Rankine power generation system 340 via the second closed flow loop 341 and feedwater pump 106 (see also FIG. 1). The downcomer conveys the working fluid downwards directly to the working fluid inlet header 515 at the bottom of and bypassing the working fluid tube bundle 512. Downcomer 517 comprises a vertically-extending pipe in one embodiment with an inlet end 517A at top located adjacent to the top header assembly 501 at the top of each heat transfer cell 352 and an outlet end 517B at bottom coupled directly to the working fluid inlet header 515. Outlet end 517B may be coupled to the header 515 in one embodiment preferably at the center of the length of the header between the ends as shown to evenly distribute the incoming feedwater to the working fluid tubes 513 coupled to the header. Accordingly, downcomer 517 is configured with at least two bends for that purpose so that the lower vertical portion of the downcomer which is fluidly coupled to working fluid inlet header 515 is located at the center of at least the lower portion of the heat exchanger tube bundles 510, 512 as shown and extends through each of the tube bundles 510, 512 to the inlet header 515. Downcomer 517 in the illustrated embodiment includes two vertical sections and a horizontal section therebetween to route the downcomer from outside the tube bundles 510, 512 at top of the heat transfer cell 352 to inside the tube bundles for coupling the header 515. The inlet and outlet ends 517A, 517B may be terminated with any suitable type of fluid end coupling such as a weld end, flanged end, or other depending on the type of piping joint to be used for coupling to the piping of the second closed flow loop 341 or the working fluid inlet header 515. The invention is not limited by the type of fluid end coupling used.

It bears noting that the downcomer 517 has a diameter substantially larger than the working fluid tubes 513 since the downcomer conveys the entire flow of working fluid (e.g., feedwater) from the condenser 105 to the inlet header 515, in which the flow is distributed to each of the tubes 513 coupled to the header.

It further bears noting that the entirety of the heat transfer fluid tube bundle 510 and working fluid tube bundle 512 is exposed directly to the thermal mass composition M inside each heat transfer cell 352 of the TES vessel 130 between the tubesheet 520 of the heat transfer fluid combined inlet-outlet header 503 at the top of the bundles and the working fluid inlet header 515 and heat transfer fluid return header 516 at the bottom of the bundles. Both the heat transfer fluid tubes 511 and working fluid tubes 513 of tube bundles 510, 512 respectively converge at the working fluid tubesheet 520 and extend at least partially into the tubesheet. The heat transfer fluid tubes 511 terminate at their ends in respective tube holes in the tubesheet 520 as previously described herein. However, the working fluid tubes 513 pass completely through tube holes in tubesheet 520 and terminate at their ends in tube holes in the curved working fluid tubesheet 521 of the working fluid outlet header 505. Tubes 513 are therefore not coupled to the tube holes in tubesheet 520 allowing them to slide up/down through the tubesheet without restraint as the working fluid tubes 513 grow and contract in length. This compensates for the differential expansion between the working fluid tubes and heat transfer fluid tubes 511 due to the difference in operating temperature between the two fluids. The upper end portions of the working fluid tubes 513 therefore pass and extend very upwards through the inlet plenum 503A and outlet plenum 503B of the heat transfer fluid combined inlet-outlet header 503 at the top of the heat exchanger 500.

The flow scheme of the heat transfer fluid and working fluid through each conjugate heat exchanger 500 is as follows. A double pass flow scheme is used in one non-limiting embodiment for the heat transfer fluid flow through the tube bundle 510 of the heat exchanger which allows the thermal mass composition M to extract a maximum amount of heat from the fluid in each heat transfer cell 352 of the TES vessel 130. In operation, heat transfer fluid in the heated or “hot” condition is conveyed from the thermal receivers 317 mounted to the power tower 316 via the first closed flow loop 311 to the heat transfer fluid combined inlet-outlet header 503 at top of the heat exchanger via inlet piping 530. The heat transfer fluid enters the inlet flow plenum 503A of the header and flows downwards through tubes 511 of tube bundle 510 to the heat transfer fluid return header 516 at the bottom of the tube bundle. The heat transfer fluid reverses direction via header 516 and then flows upwards through tube bundle 510 to the outlet plenum 503B in the transfer fluid combined inlet-outlet header 503. The now cooled heat transfer fluid exits plenum 503B via outlet piping 531 and re-enters the first closed flow loop 311 where it is pumped back to the receivers 317 by recirculation pump 319 for reheating and repeating the foregoing cycle to continuously heat the thermal mass composition when sunlight is available at the plant site. When sunlight is not available either on a cloudy day or at night, the thermal energy (heat) retained by the thermal mass composition in TES vessel 130 is transferred to the working fluid flowing through the working fluid tube bundle 513 to produce superheated steam which drives the turbogenerator to produce electricity.

A single pass flow scheme is used for flowing the working fluid through each conjugate heat exchanger 500 in one embodiment. Using water as an example of the working fluid in a Rankine power generation cycle, the boiler feedwater in a cooled condition after being discharged by the steam condenser 105 is pumped by feedwater pump 106 through the second closed flow loop 341 into the working fluid inlet downcomer 517 of heat exchanger 500. The feedwater flows downward through the downcomer and is discharged into working fluid inlet header 515 at the bottom of the working fluid tube bundle 512. The working fluid enters tubes 513 of tube bundle 512 coupled to header 515 and flows vertically upwards through the tubes and enters working fluid outlet plenum 505A of the working fluid outlet header 505 at the top of the heat exchanger and heat transfer cell 352. The water changes phase from a liquid state entering the bottom ends of the working fluid tubes 513 to superheated steam exiting the tubes in header 505 (defining the steam dome) as the water flows upwards in tube bundle 512. The steam exits header 505 and flows through the second closed flow loop 341 to the steam turbine to generate electric power via generator 103. The reduce pressure steam exits the turbine and is condensed in steam condenser 105 to complete the cycle which is repeated continuously while the power generation system 340 and TES vessel 130 are in operation. In embodiments where the steam is used for district or industrial heating purposes or processes, the steam simply flows to the end use operation, condenses, and flows back to the active heat exchangers 500 in TES vessel 130 in the liquid state to repeat the process.

As representative but non-limiting examples, heat energy derived from the CSP solar energy system stored in thermal mass composition M (e.g., Feorite™) at full charge (e.g., 600 Deg. C max temperature) in the TES vessel 130 may be about 510 million Btu (1908 MW-hr). Superheated steam output (total) from the TES vessel may be about 454,000 lb/hr (206,000 kg/hr) @1523 psia (105 bar) and 995 Deg. F (535 deg. C).

Although the foregoing process and flow scheme is considered optimal in one embodiment, it will be appreciated that numerous variations in the flow scheme of the heat transfer fluid and working fluid through the heat exchangers are possible.

Each conjugate heat exchanger 500 may be independently supported by the support partition structure 350 disposed inside internal cavity 140 of TES vessel 130. In one embodiment, a plurality of outwardly and radially extending support beams 560 are coupled to each heat exchanger which supports the heat exchanger in its heat transfer cell in a vertically suspended manner from the partition structure. A first inboard end 560A of each support beam is fixedly coupled to the heat exchanger 500 and an opposite second outboard end 560B of the support beam is fixedly coupled to the top of the cell walls 351 of the heat transfer cell. The support beams are therefore located at the top portion of the cells walls and the TES vessel 130 as shown. In one non-limiting embodiment as shown, the inboard ends 560A of each beam may be fixedly coupled such as via welding to the sidewall 523 of the heat transfer fluid combined inlet-outlet header 503. The outboard ends 560B may each be fixedly coupled to the top ends 356 such as via welding or other methods such as welded angle clips as some non-limiting example. In one embodiment, each of the angled cell walls 351 of each hexagonal heat transfer cell 350 may be coupled to and engaged by one of the support beams 560 of each heat exchanger as shown. This provides maximum lateral support for the heat exchanger and particularly the top header assembly 501 in the case of a seismic event. Each support beam in one embodiment may be formed by suitable steel structural members such as H or W structural beams, or a welded assemblage of beams and/or plates. The heat exchanger support beams 560 may be linearly and horizontally elongated structures in some embodiments as shown. In some arrangements, the outboard ends 560B of the support beams 560 may be abutted against the outboard ends of adjacent support beams which have the same horizontal alignment for an efficient support structure. Adjacent ends of support beams where they occur may also be coupled together for added structural stiffness and rigidity which ties the overall heat exchanger support system for the TES vessel together. It bears noting that tube bundles 510, 512 of the heat exchanger 500 within the modules may receive at least partial lateral support from the thermal mass composition M inside the module once filled with the composition.

As previously mentioned herein, the heat transfer cells 352 in some embodiments may each be formed by complete individual modular units referred to herein as heat transfer modules 355 (sec, e.g. FIG. 35). Each module includes a plurality of angled cell walls 351 joined along their vertical edges to form an enclosed spaced defining a heat transfer cell 352. Module 355 therefore comprise a tubular body formed by the cell walls, and may be hexagonal in configuration as shown in one non-limiting embodiment. Other tubular configurations of modules may be provided with different polygonal transverse cross sectional shapes to define different shaped cells as previously described herein.

Each heat transfer module 355 can be shop fabricated and shipped to the plant installation site for insertion into and mounting inside internal cavity 140 of the TES vessel 130 if small enough to be transportable via any conventional shipping means (e.g., truck, rail, ship). Each heat transfer module is therefore a self-supporting transportable module comprised of a plurality of coupled cells walls 351 which encloses the sides of and defines the cell 352, a bottom baseplate 359, and preferably one of the heat exchangers coupled to and supported by the cell walls by the support beams 560. In other embodiments the heat exchangers can be mounted to each module 355 after installation in the TES vessel 130 if needed. Baseplate 359 is welded to the bottom ends of the walls 351 in one embodiment to enclose the bottom end of the cell. In alternative embodiments, the baseplate could be omitted and the bottom ends of the cell walls could be positioned on the bottom closure plate of the TES vessel 130 directly. Shop fabricated heat transfer modules 355 can advantageously be fabricated and assembled with a greater degree of precision in a clean environment and inspected fully before shipment to the site in contrast to field fabrication of the modules. The modular system also allows use of robotically controlled welding equipment for fabricating and assembling the cells walls, heat exchangers, and support beams accurately under shop conditions which results in more efficient and economic fabrication of the highest quality.

Each prefabricated heat transfer module 355 with physically isolated inventory of thermal mass composition M defines an independently operable heat transfer cell 352 equipped with one of the heat exchangers 500.

As shown in FIG. 1, some embodiments may optionally be provided with an array of photovoltaic (PV) solar panels to form a hybrid solar energy system 600 which will now be described in additional detail. The hybrid solar energy system 600 comprises the combination of the concentrated solar power (CSP) energy system 310 with solar collector 312 and addition of the photovoltaic (PV) solar energy system 606; each of which are thermally and operably coupled indirectly to the power generation system 340 in one embodiment through the TES vessel 130 as described herein. The power generation system comprises the steam turbine 102 and electric generator 103 (turbogenerator) for generating electricity via the Rankine steam power generation cycle as previously described herein. The hybrid solar energy system 600 is part of the overall solar power generation system 300 and adds a third closed flow loop 615 fluidly coupled to the first closed flow loop 311. The third closed flow loop includes electric heaters which supplement heat provided by the CSP energy system 340 which is described in greater detail below. It bears noting that in other possible embodiments, steam generated by the thermal energy storage (TES) vessel 130 of the hybrid solar energy system 600 may be used directly for industrial processes/applications or district heating in lieu of powering a Rankine power generation cycle to produce electricity.

The PV array 604 comprises a plurality of photovoltaic solar panels 602 sited in available areas of land at the solar power operating site lying around and adjacent to the array of heliostats 313 associated with the CSP solar collector 312.

The solar panels 602 convert incident solar thermal energy from the sun into direct current (DC) electric power in the usual manner. The solar panels are electrically coupled together to collect and combine the electric power output from the plurality of panels via runs or networks of suitable electric wiring 605. The collective electric output from the solar panels may be routed to an electric switching system 610 (represented schematically by the dashed box in FIG. 1). The switching system comprises an assembly of suitable commercially-available electric switchgear which is arranged and configurable to direct the electric power generated by the PV array 604 to either (1) the electric power grid 612 for sale when there is demand, or (2) to a plurality of electric energy injector (EEI) units 620 noted above for providing supplemental heating of the heat transfer fluid as further described herein. In the former situation for direct sale of the electricity produced by the PV array 604 to the power grid, a current inverter 608 is provided to change the current to alternating current (AC) compatible with the electric power of the grid. The switching system 610 is further configurable to direct electric power extracted from the electric power grid 612 to the electric heaters when the photovoltaic array is not in operation. When demand is low on the electric power grid such as during certain seasons and/or hours of the day, the cost of energy used from the grid drops so it may be beneficial to operate the auxiliary heating vessel 620 using grid power during those period and store the energy via the thermal energy storage vessel 130 as further described herein.

To use the electricity produced by the PV array 604 for supplemental heating of the heat transfer fluid flowing through the first closed flow loop 311 associated with the concentrated solar power (CSP) energy system 310, a third closed flow loop 615 is provided as shown in FIG. 1. The third closed flow loop is fluidly interconnected and coupled to the first closed flow loop 311 at two junctures as shown to both extract the heat transfer fluid from the first closed flow loop, and return the heat transfer fluid to the first closed flow loop after being heated in the auxiliary heating vessel 620. The inlet 611 of the third closed flow loop 615 is fluidly coupled to the first closed flow loop 311 downstream TES vessel 130 (outlet fluid side 130b TES vessel) to extract the heat transfer fluid after being heated by the thermal mass composition M in the vessel. Conversely, the outlet 612 from the third closed flow loop 615 is fluidly coupled to the first closed flow loop 311 at the inlet fluid side 130a of the TES vessel before the heat transfer fluid flows through and picks up heat from the thermal mass composition. In one embodiment, both the first and third closed flow loops 311, 615 may be fluidly coupled to the top inlet header 335a associated with the heat exchange tubes 511 of the first closed flow loop which conveys the heat transfer fluid through the TES vessel 130 for heating. In this case, the top inlet header 335a forms a common or shared header and collection point for combining heat transfer fluid flowing through the first and third closed flow loops 311, 615.

The third closed flow loop 615 is formed by flow conduits 616 which form integral external portions of the flow loop to circulate the heat transfer fluid therethrough as further described herein. In one embodiment, the flow conduits 616 may be formed by piping made of a material suitable for handling the temperatures, pressures, and chemistry of the heat transfer fluid. The flow conduits 616 may be insulated and if necessary heat traced in some embodiments to minimize heat loss from the heat transfer fluid flowing through the third closed flow loop 615.

According to another aspect of the invention, supplemental heating of the heat transfer fluid (e.g., molten salt or synthetic heat transfer oil) in conjunction with the CSP solar energy system 310 comprising solar collector 312 may be accomplished using electric heaters. Electric power can be derived from either an onsite array of photovoltaic (PV) solar panels or using electricity extracted from the electric power grid during low demand periods when electric energy is cheaper if economically feasible.

Referring to FIGS. 3-16, a plurality of electric energy injector (EEI) units 620 may be provided which are sized to fit in the empty peripheral regions PI of TES vessel 130 between the partition structure 350 and shell 131 too small to accommodate heat exchangers 500. The EEI units may be perimetrically spaced apart around peripheral region PI inside the top of the internal cavity 140 of the vessel 130. The units may be supported from the shell 131 and/or cell walls 351 of the heat transfer cells 352 by suitable attachment means including for example without limitation brackets or clips. Each EEI unit is mounted adjacent a top end of the heat transfer cells and supported by the cell walls of the cells in one embodiment.

The third closed flow loop 615 in one embodiment further includes a plurality of recirculation pumps 630 which provide the motive force to recirculate the heat transfer fluid through the third closed flow loop 615 (i.e. both extract from and return the heat transfer fluid to the first closed flow loop 311) and the plurality of EEI units 620. In one embodiment as shown, each EEI unit 620 therefore has its own dedicated pump 630 which may each be mounted to and directly supported by top plate 625 of the unit for convenience to form a compact assembly, as further described below. The EEI units 620 and pumps 630 are each integral fluidic parts of the third closed flow loop 615. The pumps control the flow of heat transfer fluid to each electric energy injector unit separately, thereby allowing one or any number of EEI units to be operated at any given time. Each pump 630 is fluidly coupled to the third closed flow loop 615 via suitable flow distribution and return flow headers which distribute the heat transfer fluid circumferentially around the TES vessel 130 to each electric energy injector unit and collect/return the heated heat transfer fluid from each unit back to main piping of the third closed flow loop 615. Inlet and outlet flow conduits are provided with each electric energy injector unit to fluidly couple the units to the headers. It is well withing the ambit of those skilled in the art to provide and configure suitable flow distribution and return headers and flow conduits to meet the application at hand without undue elaboration or details provided here.

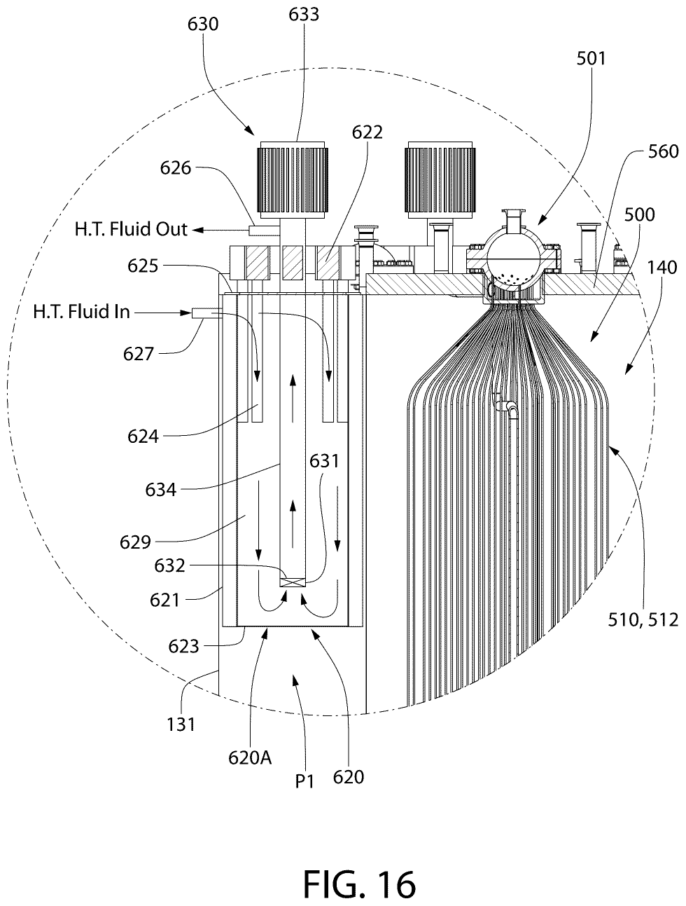

With continuing reference to FIGS. 3-16, each EEI unit 620 may comprise a vertically oriented hollow tank 620A, one of the heat transfer fluid pumps 630, and a plurality of electric heaters 622 having heating elements 624 (best shown in FIGS. 7 and 16). Tank 620A comprises a cylindrical shell 621 which forms a circumferential sidewall of the tank, a top plate 625 fixedly coupled to the top end of the tank, and a bottom plate 623 fixedly coupled to a bottom end of the tank. An internal cavity 629 defined inside tank 620A receives a flowing volume of heat transfer fluid (e.g., molten salt or heat transfer oil) for heating and return to the third closed flow loop 615 and in turn to first closed flow loop 311 from which the fluid was extracted initially, as further described herein. The internal cavities of the EEI units are collectively integral fluidic parts of the third closed flow loop 615. At least the sidewall shell 621 of auxiliary heating vessel 620 may be insulated for heat retention. Preferably, the top and bottom plates are insulated as well when possible.

On the heat transfer fluid side, each EEI unit 620 further includes a dedicated heat transfer fluid pump 630 as noted above, a fluid inlet nozzle 627, and fluid outlet nozzle 626. The nozzles may each be formed by short sections of piping with suitable end preparations and configurations for fluid coupling to the flow conduits 616 of the third closed flow loop 615. In one embodiment, a commercially available vertical pump may be used for pump 630. In these type pumps, the impeller 632 is mounted inside and at the bottom of the hollow vertical discharge column 634 (e.g., tube or pipe) of the pump adjacent to the pump intake 631 thereon. The intake 631 is located near but spaced apart from the bottom of the tank 630A. The motor 633 of this type pump is located and mounted on top plate 625 of the EEI tank 620A. The fluid inlet nozzle 627 may be coupled to and penetrate an upper portion of the tank shell 621 in some embodiment. The outlet nozzle 626 is disposed and fluidly coupled to the exposed upper portion of the discharge column 634 of the pump above the top plate 625.

In one embodiment, cooled heat transfer fluid exiting the TES vessel 130 may enter an upper portion of the internal cavity 629 each EEI unit tank 620A. The heat transfer fluid flows vertically downwards in the tank through heating elements 624 of the electric heaters 622 to the bottom where it is drawn into the intake 631 at the bottom of discharge column 634 by the impeller 632 of pump 630. The heat transfer fluid is pumped upward through column 634 and exits the pump laterally via outlet nozzle 626.

The plurality of electric heaters 622 in each EEI unit 620 are configured and operable to heat the heat transfer fluid as it flows through the internal cavity 629 of the tanks 620A. In one embodiment, heaters 622 may be commercially available industrial electric immersion heaters each comprising elongated heating elements 624 which extend into the internal cavity 629 of the EEI unit tank 620A to directly contact the volume of heat transfer fluid stagnantly held therein (if the pump 630 on the EEI unit is not in operation), or flowing therethrough (when pump 630 is in operation). Any suitable configuration of heating elements may be used such as linear rods, U-shaped rods, etc. Preferably, the heating elements 624 extend for a sufficient height of the internal cavity 629 to effectively heat the heat transfer fluid in the EEI unit. Any suitable configuration of heating elements may be used such as linear rods, U-shaped rods, etc.

In one embodiment, the electric heaters 622 may be mounted on the top plate 625 of the EEI unit tank 620A vessel for support and heating elements 624 may therefore extend downwards therefrom being vertically elongated. This placement facilitates replacement of individual heaters if needed when the heating elements burn out or become damaged without need for completely emptying the vessel.

Electric heaters 622 are electrically coupled to the electric switching system 610 via electric wiring 605 to selectively receive electric power from either the PV array 604 or electric power grid 612 described elsewhere herein (sec, e.g., FIG. 1). Heaters may be configured for powering by DC (direct current) electric power from switching system 610 generated directly by the PV array. In other embodiments, the heaters 622 may be powered by AC electric power instead taken from the inverter 608. Accordingly, the electric heaters 622 selected may be operated via either DC or AC electric power and is not limiting of heat invention.

In some embodiments as illustrated in structural figures, multiple EEI units 620 are provided which are mounted inside the TES vessel 130 near the top (see, e.g. FIGS. 9-11). The units 620 may be fluidly coupled to the third closed flow loop 615 via suitable piping and header arrangement which is well within the ambit of those skilled in the art to provide without undue elaboration. For clarity of depiction to avoid unduly cluttering the drawing, however, the schematic flow diagram of FIG. 1 shows only a single EEI unit as a representation of a plurality of electric energy injector units which are mounted inside the TES vessel 130. Although the heat transfer fluid pump 630 associated with the electric energy injector units 620 are disclosed as being is mounted directly on unit for compactness, in other possible embodiments the pumps 630 could be mounted near each EEI unit but not necessarily directly on the unit. It further bears noting that some of the EEI units 620 in various drawings are shown without a pump 630 for clarity recognizing that each unit in the non-limiting illustrated embodiment includes a pump, nonetheless. In yet other embodiments, the EEI units could be mounted externally on or near the TES vessel 130.

The EEI units 620 for using electric heat to supplement heating of the thermal mass composition M in the TES vessel 130 may be used in various ways and scenarios for operating the plant.

In the event the thermal mass composition M is depleted of sufficient thermal energy to heat the second working fluid associated with power generation system 340 to the desired steam operating conditions necessary to generate electric power (e.g., steam pressure and temperature), the EEI units 620 may be used as back up to heat the composition in the TES vessel 130. This scenario may occur when electric power generation is needed at night after sunset when solar energy is not available to recharge the bed of thermal mass composition M. This is a very real scenario particularly in hot locations like the desert climate states of the southwest United States where summer temperatures can remain at or above 100 degrees F. after sunset, by continuing the high electric demand period of the day for cooling. One or more of the EEI units 620 can then be energized by drawing electric power from the utility electric power grid or the photovoltaic (PV) array previously described herein to heat the thermal mass composition M to necessary operating temperatures for generating electricity. In another scenario, the solar radiation incident on the solar collector 312 may be insufficient to adequately heat the bed of thermal mass composition M in TES vessel 130 to the necessary operating temperature due to cloud cover in some locations where the solar power generation system 300 might be sited. The EEI units 620 may be operated in this case during off-peak demand periods of the power grid when energy costs are lowest if possible to recharge the thermal mass composition. Since the incident solar radiation is not sufficient to operate the solar collector, the same would hold true for the PV array which would be unavailable to generate electricity. Electric power is input to the heaters 622 of the EEI units 620 until the thermal mass composition M is heated to its normal operating temperature Tnm temperature and optimum heat retention capacity. Power can then be terminated from the power source. The thermal mass composition is now fully thermally charged and in a standby condition ready for operation when needed for heating the working fluid and producing steam for power generation, district heating, or industrial used.

Each of the first and third closed flow loops 311, 615 disclosed herein also include valving comprising a plurality of valves changeable between open and closed positions. The valving (valves) of the first closed flow loop 311 are given the common designation “640” and valving (valves) of the third closed flow loop 615 are given the common designation “642” in the figures (see, e.g., FIG. 1). Selectively changing the positions of various sets of these valves allows a plurality of flow path configurations to be established to configure the flow loops for combining flow from the first and third flow loops, or fluidly isolating these flow loops.

As one example, in a first flow scenario, the EEI units 620 may be used as the sole means for heating the heat transfer fluid via electric power derived from either the PV array 604 or electric power grid 612 when the concentrated solar power collector 312 is removed from service (i.e. not operated) such as for maintenance. The heated heat transfer fluid in turn yields its heat to heat the heat transfer fluid and in turn the thermal mass composition M in the thermal energy storage (TES) vessel 130. In this case, the first and third closed flow loops are configurable via selecting positions of the valving 640, 642 to form a first flow path configuration in which the heat transfer fluid is circulated via the plurality of heat transfer fluid pumps 630 and third closed flow loop 615 through the thermal energy storage vessel 130 and the electric energy injector units 620 but bypassing the concentrated solar power collector 312 portion of the first closed flow loop 311 which is fluidly isolated from third closed flow loop. Referring to FIG. 1, both valves 642 in the third closed flow loop 615 are open while both valves 640 in the first closed flow loop 311 are closed to fluidly isolate the concentrated solar power collector 312 from the third closed flow loop and TES vessel 130. This flow path configuration may also be used during startup of the TES vessel 130 using only the EEI units 620 to heat the heat transfer fluid and in turn the thermal mass composition in the vessel to raise its temperature up to operating temperature. Pumps 630 of the electric energy injector units therefore may be operated to circulate the heated heat transfer fluid through the third closed flow loop 615 and in turn the TES vessel 130 to heat the thermal mass composition M in the TES vessel up to minimum operating temperature required to keep molten salt in the liquid phase when introduced into the TES vessel from the CSP system.

At a certain point in time therefore such as when the minimum operating temperature noted above is reached as noted above, the previously closed valves 620 of the first closed flow loop 311 can be opened to combine flow from the first and third closed flow loops thereby placing the concentrated solar power collector 312 in active operation again to also heat the heat transfer fluid for in turn heating the thermal mass composition M in the TES vessel 130. In this second flow scenario, the electric energy injector units 620 are being used to “supplement” the heat input to the heat transfer fluid already provided by the concentrated solar power collector 312. The concentrated solar power collector 312 in one embodiment provides the majority of the heat input to the heat transfer fluid whereas the electric energy injector units 620 (i.e. electric heaters 622) provides a lesser amount of heat input thereto. Accordingly, the CSP collector 312 may be considered to produce “primary” heated heat transfer fluid while the electric heaters of the electric energy injector units 620 may be considered to produce “supplementary” heated heat transfer fluid since the heat added by the electric heaters supplements the heat added to the heat transfer fluid by the CSP collector. Alternatively, operation of the electric energy injector units may be completely discontinued and the CSP collector alone heats the heat transfer fluid.

The first and third closed flow loops are therefore configurable via valving 640, 642 in each respectively to form the foregoing second flow path configuration in which the heat transfer fluid is circulated via pumps 319 and 630 through the thermal energy storage vessel 130 and the EEI units 620 in combination with being circulated through the concentrated solar power collector 312. The additional or supplemental heat input to heat transfer fluid provided by the electric energy injector units 620 ultimately increases heating of the thermal mass composition M, which in turn results in an increase in the heating and enthalpy of the second working fluid flowing through the second closed flow loop 341a associated with the power generation Rankine cycle. Accordingly, compared to operating the concentrated solar power collector 312 alone, the superheated steam leaving the TES vessel 130 and flowing to the steam turbine 102 has increased enthalpy due to the heating contribution of the electric energy injector units 620. This results in greater electric power output as the steam turbine 102 can perform more mechanical work due to the increased energy input by the steam. This also results in a boost in efficiency of the Rankine cycle.

In a third flow path configuration, the valving 642 in the third closed flow loop 615 may be configured (i.e. closed) to fluidly isolate the electric energy injector units 620 and third closed flow loop from the first closed flow loop 311. In some operating situations, the additional heat input to the heat transfer fluid by the electric energy injector units may not be needed or the electric power produced by the PV array 604 may be more valuable for provision to the electric power grid 612. In this case, the heat transfer fluid is only heated by the concentrated solar power collector 312 via the first closed flow loop by opening valves 640 therein.

In view of the foregoing, it is evident that the electric energy injector units 620 in combination with the concentrated solar power collector 312 provides considerable operational flexibility afforded by the hybrid solar energy system 600.

The second closed flow loop 341 that circulates the second working fluid associated with the Rankine steam power generation system 340 also includes an appropriate number of valves 641 which can be changes between closed and open positions to fluidly isolate and connect the steam turbine 102 and other fluidic components of the power generator system from/to the TES vessel 130.

Any suitable commercially-available valves may be used for valves 640, 641, and 642 noted above which are rated for the type of fluid handled and its operating conditions (e.g., pressure and temperature) for each of the first, second, and third flow loops.

The heat transfer fluid may be molten salt or a synthetic heat transfer oil. Other suitable available heat transfer fluids may be used when appropriate and beneficial. Where the demand for pressure and temperature of steam is relatively moderate, a suitable synthetic oil may be used as the heat transfer fluid. Synthetic oils can be used effectively where <400 degree C. (Celsius) maximum temperature limit can be maintained. Such a situation may be where the steam output by the TES vessel 130 might be used for industrial steam applications or district heating. Because of their low freezing point, a solar collector using a synthetic oil may not need heat tracing of the system's piping and vessels. For higher pressure and temperature steam requirements such as commonly encountered with operation of a Rankine power generation cycle system as described herein, molten salt may be desired for the heat transfer fluid. It is well within the ambit of those skilled in the art to select an appropriate working fluid for the intended application.

The TES vessel 130 (“green boiler”) which stores the solar-derived thermal energy via the concentrated solar power collector 312 and PV array 604 described above combines sensible as well as latent heat storage to yield high storage capacity and a long service life (estimated to be over 50 years). The solar-related equipment of present hybrid solar energy system 600 can be arranged and configured in a layout on the ground at the operating site in a way that optimizes the use of land, which analysis shows, provides twice as much power for the same land area as the best conventional solar power systems. The system can therefore generate and provide electric power 24 hours, 7 days per week.

In the clean energy eco-system as summarized above, photovoltaic solar panels 602 provide electric power directly into the grid during a greater part of the day. However, during peak solar times and off-peak power use times, the PV array generated electric power can be fed into the thermal storage system (e.g., TES vessel 130) to store energy as high temperature heat via the thermal mass composition. The CSP system collects heat at high temperatures during the day, but most of that heat is fed into the TES vessel heat storage system for high temperature thermal storage. The CSP system and the TES vessel provide heat to make high temperature, high pressure steam which would run a turbogenerator. Electric power from the steam power plant is fed into the power grid via the generator 103.

The solar panels 602 of the PV array may be located in the solar field (i.e. land surface area which receives incident solar energy from the sun at the operation site) in a way that efficiently utilizes all of the available area of the site that would otherwise remain unused by the concentrated solar power (CSP) collector 312 since the heliostats must at least partially encircle the power tower to focus sunlight on the thermal receiver(s) on the tower. These “dead areas” include the field portions adjacent to the power tower, and outside the at least partially circular array of CSP heliostats at a distance too remote from the tower to be useable to effectively focus sunlight on the thermal receiver(s) of the tower. The dead areas unusable for the CSP portion of the system are created because the land is normally available as a rectangular configuration for the solar energy system operating site. The land area close to the tower is unusable because heliostats in that arca cannot efficiently focus sunlight on the thermal receiver at the top of the tower due to their close proximity.

Any suitable commercially-available pumps may be used for any of the pumps disclosed herein. Selection of the appropriate and type of pump will be based on the type of fluid to be pumped and its operating conditions (e.g., pressure and temperature) for each flow loop or equipment, which is well within the ambit of those skilled in the art.

Any suitable method used in the art may be used for forming the fluid couplings or connections disclosed herein between equipment and/or flow conduits such as via welded joints, bolted and flanged joints, or other fluid coupling techniques.

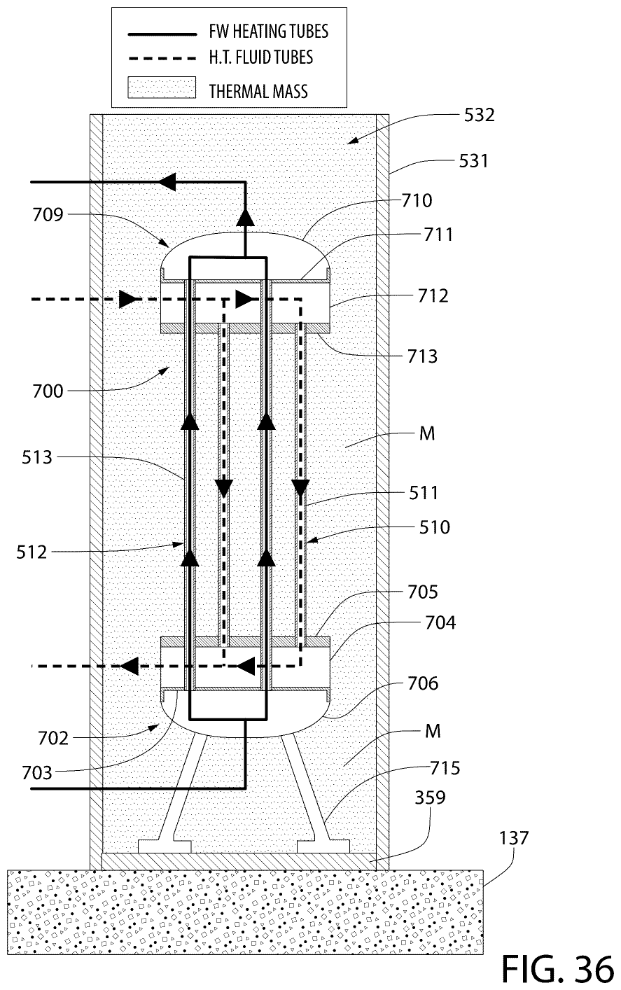

FIG. 36 is a schematic illustration of an alternative embodiment of a conjugate heat exchanger designated as heat exchanger 700 which is a single pass heat exchanger. Heat exchanger 700 is shown disposed in a heat transfer cell 532 and embedded in the thermal mass composition M with the heat transfer fluid and working fluid tubes 511 and 513 in direct conformal contact with the composition. The linearly elongated headers 515, 516 previously described herein for the bottom header assembly are replaced by a stacked bottom header assembly 702 comprising heat transfer fluid outlet header 704 coupled directly to working fluid inlet header 706. Header 704 comprises tubesheet 705 to which bottom ends of the heat transfer fluid tubes 511 of tube bundle 510 are fixedly coupled. Header 706 comprises tubesheet 703 to which bottom ends of working fluid tubes 513 of tube bundle 512 are fixedly coupled. Working fluid tubes 513 pass through the heat transfer fluid outlet header 704 as shown which advantageously preheats the cool working fluid returned from the condenser 105 of the Rankine cycle or condensate collected from steam heating applications.

A similar stacked top header assembly 709 may be provided at top of heat exchanger 700 comprising working fluid outlet header 710 coupled directly to heat transfer fluid inlet header 711. Header 710 which collects steam as the working fluid (e.g., water) changes phase as it rises through tubes 513 is therefore preferably mounted on top of the heat transfer fluid inlet header 712 as shown for that reason. The working fluid outlet header 710 is further preferably dome shaped to better collect the steam which is conveyed to the second closed flow loop 341 to the steam turbine 102 (or steam heating application).

Heat exchanger 700 is shown as a single pass heat exchanger on both the heat transfer fluid (e.g., molten salt or synthetic heat transfer oil) and working fluid (e.g., water) flow through the heat exchanger.

In lieu of being suspended from top ends of the heat transfer cell walls 531 as in the previous heat exchanger 500 described herein, heat exchanger 700 may be supported by a plurality of support legs 715 seated on and coupled to baseplate 359 of the cell 532 which allows the heat exchanger to grow vertically upward due to thermal expansion. Baseplate 359 in turn may be seated directly on concrete slab 137 or alternatively on bottom closure plate 135 of the TES vessel which in turn is seated on the slab. In other embodiments, baseplate 359 may be omitted and legs 715 may instead be seated on bottom closure plate 135 of the TES vessel.

Although heat exchanger 700 is shown completely embedded and submerged in the thermal mass composition M, in other embodiments the top header assembly 709 may be disposed above and out of the thermal mass composition. A plurality of heat exchangers 700 if used are each disposed in a separate heat transfer cell 532 with its own discrete and physically isolated inventory or bed of thermal mass composition in the same manner previously described herein for conjugate heat exchangers 500.

Although the heat transfer cells of the TES vessel are described and shown as being vertically oriented in some embodiment disclosed herein, in other possible applications such as industrial uses cells be arranged in a horizontal orientation.

Example Embodiments

The following are non-limiting example embodiments of the invention.
1. A solar energy system comprising:
a thermal energy storage system comprising a vessel forming an internal cavity;
a partition structure dividing the internal cavity into at least two heat transfer cells;
each of the at least two heat transfer cells containing an inventory of a thermal mass composition; and
a heat exchanger disposed in each of the at least two heat transfer cells, each heat exchanger comprising a first tube bundle embedded in the thermal mass composition.
2. The system according to embodiment 1, wherein the first tube bundles of the heat exchangers are in fluid communication with a first common fluid source; and wherein each of the first tube bundles of the heat exchangers can be independently isolated from the common fluid source while allowing the other ones of the heat exchangers to remain in operable fluid communication with the first common fluid source.
3. The system according to embodiments 1 to 2, wherein each of the heat exchangers are independently operable.
4. The system according to any one of embodiments 1-3, wherein the thermal mass composition inside each heat transfer cell is operable to store heat and isolated from the thermal mass composition of the other heat transfer cells.
5. The system according to any one of embodiments 1-4, wherein the vessel comprises an outer shell defining a sidewall, and a bottom closure plate coupled to a bottom end of the shell.
6. The system according to embodiment 5, wherein each of the at least two heat transfer cells is vertically elongated and formed by vertical cell walls which extend upwards from the bottom closure plate.
7. The system according to embodiment 6, wherein the cell walls of each of the at least two heat transfer cells have bottom ends abuttingly engaged with the bottom closure plate of the vessel to prevent the thermal mass composition in each cell from substantially comingling with the thermal mass composition of the other cells.
8. The system according to embodiment 7, wherein the bottom ends of cell walls of the heat transfer cells are fixedly coupled to the bottom closure plate.
9. The system according to any one of embodiments 5-8, wherein the cell walls of each heat transfer cell extend for at least 90 percent of a height of the internal cavity of the vessel.
10. The system according to any one of embodiments 1-9, wherein the partition structure is configured to form the at least two heat transfer cells with a polygonal transverse cross-sectional shape.
11. The system according to embodiment 10, wherein the at least two heat transfer cells have a hexagonal transverse cross-sectional shape.
12. The system according to any one of embodiments 2-11, wherein each heat exchanger further comprises a second tube bundle embedded in the thermal mass composition in each of the at least two heat transfer cells, the second tube bundles each in fluid communication with a second common fluid source different than the first common fluid source.
13. The system according to embodiment 12, wherein the first common fluid source comprises a first closed flow loop circulating a heated heat transfer fluid which heats the thermal mass composition in each of the at least two heat transfer cells, and the second common fluid source comprises a second closed flow loop circulating a working fluid heated via absorbing heat from the thermal mass composition.
14. The system according to embodiment 13, wherein the first closed flow loop comprises a solar collector which heats the heat transfer fluid via sunlight, the working fluid changes phase in each heat exchanger from a liquid to steam via absorbing heat from the thermal mass composition, and the closed flow loop comprises a turbogenerator of a Rankine power generation system which receives the steam to generate electricity.
15. The system according to any one of embodiments 12-14, further comprising a plurality of radially extending support beams which support each heat exchanger in the at least two heat transfer cells in a vertically suspended manner from the partition structure.
16. The system according to embodiment 15, wherein a first end of each support beam is coupled to the heat exchanger and an opposite second end of the support beam is coupled to a top end of the cell walls of the at least two heat transfer cells.
17. The system according to any one of embodiments 12-16, wherein each of the at least two heat transfer cells is formed by a self-supporting transportable heat transfer module with a tubular structure formed by a plurality of the cells walls.
18. The system according to embodiment 17, wherein the heat transfer modules collectively define the partition structure of the vessel.
19. The system according to embodiments 17 or 18, further comprising a baseplate coupled to bottom ends of the cells walls of each heat transfer cell, the baseplate configured to rest on a top surface of the bottom closure plate of the vessel.
20. The system according to any one of embodiments 12-19, wherein each heat exchanger comprises a stacked top header assembly including a first header defining a heat transfer fluid plenum fluidly coupled to the first tube bundle, and an adjacent second header defining a working fluid outlet plenum fluidly coupled to the second tube bundle, the heat transfer fluid plenum fluidly isolated from the working fluid outlet plenum.
21. The system according to embodiment 20, wherein the heat transfer fluid plenum is divided by a partition plate into a heat transfer fluid inlet plenum and heat transfer fluid outlet plenum.
22. The system according to embodiment 21, wherein the first header includes a first tubesheet to which top ends of first tubes of the first tube bundle are coupled, and the second header includes a second tubesheet to which top ends of second tubes of the second tube bundle are coupled, the first and second tubesheets being spaced apart to define the heat transfer fluid plenum therebetween.
23. The system according to embodiment 22, wherein the second tubes pass through the first tubesheet and the heat transfer fluid plenum to the second tubesheet.
24. The system according to embodiment 23, wherein the second tubes are slideably received through the first tubesheet without being affixed thereto.
25. The system according to any one of embodiments 22-24, wherein the second header has a spherical shape comprising a bottom half and a separate top half detachably coupled to the bottom half.
26. The system according to embodiment 25, wherein the bottom half defines the second tubesheet which is arcuately curved and welded to the first header such that the second tubesheet protrudes downwards into the heat transfer fluid plenum.
27. The system according to embodiments 25 or 26, wherein the top half of the working fluid outlet header is arcuately curved forming a steam dome including a centered outlet nozzle.
28. The system according to any one of embodiments 20-27, further comprising a bottom heat transfer fluid return header fluidly coupled to bottom ends of the first tubes of the first tube bundle, and a bottom working fluid inlet header fluidly coupled to bottom ends of the second tubes of the second tube bundle.
29. The system according to embodiment 28, further comprising a working fluid downcomer having a portion extending through the first and second tube bundles which is coupled to the bottom working fluid inlet header.
30. The system according to any one of embodiments 1-29, further comprising a plurality of electric energy injector units disposed in an empty peripheral region of the vessel between the partition structure and the shell, each unit comprising a tank which circulates a portion of the heat transfer fluid therethrough and a plurality of electric heating elements operable to heat the heat transfer fluid.
31. The system according to any one of embodiments 12-30, wherein the working fluid is water and the heat transfer fluid is molten salt or heat transfer oil.
32. A solar energy system comprising:
a heat transfer module comprising:
   a tubular structure configured for installation in a thermal energy storage vessel and to receive an inventory of a thermal mass composition operable to store thermal energy, the tubular structure defining a heat transfer cell extending between top and bottom ends of the tubular structure;
   a heat exchanger disposed in the heat transfer cell and supported by the tubular structure, the heat exchanger comprising exposed first and second tube bundles configured for embedment in the thermal mass composition;
   the first tube bundle configured to receive and circulate a heat transfer fluid heated by a solar collector of the solar energy system to heat the thermal mass composition; and
   the second tube bundle configured to receive and circulate a working fluid which is heated via absorbing heat from the thermal mass composition.
33. The system according to embodiment 32, wherein the heat transfer module is a self-supporting transportable module.
34. The system according to embodiments 32 or 33, further comprising a baseplate coupled to the bottom end of the tubular structure.
35. The system according to any one of embodiments 32-34, further comprising a plurality of radially extending support beams coupled to the heat exchanger which support the heat exchanger from the tubular structure in a vertically suspended manner.
36. The system according to embodiment 35, wherein a first end of each support beam is coupled to the heat exchanger and an opposite second end of the support beam is coupled to a top end of the tubular structure.
37. The system according to embodiment 36, wherein the first end of each support beam is coupled to a top cylindrical header of the heat exchanger.
38. The system according to any one of embodiments 32-37, wherein the heat transfer cell has a polygonal shape in transverse cross section formed by a plurality of angled cell walls.
39. The system according to embodiment 38, wherein the heat transfer cell has a hexagonal cross-sectional shape.
40. The system according to any one of embodiments 32-39, wherein each heat exchanger comprises a stacked top header assembly including a first header defining a heat transfer fluid plenum fluidly coupled to the first tube bundle, and an adjacent second header defining a working fluid outlet plenum fluidly coupled to the second tube bundle, the heat transfer fluid plenum fluidly isolated from the working fluid outlet plenum.
41. The system according to embodiment 40, wherein the heat transfer fluid plenum is divided by a partition plate into a heat transfer fluid inlet plenum and heat transfer fluid outlet plenum.
42. The system according to embodiment 41, wherein the first header includes a first tubesheet to which top ends of first tubes of the first tube bundle are coupled, and the second header includes a second tubesheet to which top ends of second tubes of the second tube bundle are coupled, the first and second tubesheets being spaced apart to define the heat transfer fluid plenum therebetween.
43. The system according to embodiment 42, wherein the second tubes pass through the first tubesheet and the heat transfer fluid plenum to the second tubesheet.
44. The system according to embodiment 43, wherein the second tubes are slideably received through the first tubesheet without being affixed thereto to allow the second tubes to thermally expand relative to the first tubesheet.
45. The system according to any one of embodiments 40-44, wherein the second header has a spherical shape comprising a bottom half and a top half detachably coupled to the bottom half.
46. The system according to embodiment 45, wherein the bottom half defines the second tubesheet which is arcuately curved and welded to the first header such that the second tubesheet protrudes downwards into the heat transfer fluid plenum.
47. The system according to embodiments 45 or 46, wherein the top half of the working fluid outlet header is arcuately curved forming a steam dome configured to collect the steam from the second tubes of the second tube bundle.
48. The system according to any one of embodiments 32-47, further comprising a bottom heat transfer fluid return header fluidly coupled to bottom ends of the first tubes of the first tube bundle, and a bottom working fluid inlet header fluidly coupled to bottom ends of the second tubes of the second tube bundle.
49. The system according to embodiment 48, further comprising a working fluid downcomer having a portion extending through the first and second tube bundles which is coupled to the bottom working fluid inlet header.
50. A method for installing a solar energy system, the method comprising:
providing or having a thermal storage energy vessel defining an internal cavity;
providing or having a plurality of self-supporting heat transfer modules, the modules each including a tubular structure which defines a heat transfer cell, and a heat exchanger supported by the tubular structure, each heat exchanger comprising a first tube bundle configured to convey a heat transfer fluid heated by a solar collector of the solar energy system and a second tube bundle configured to convey a working fluid;
lifting a first module of the plurality of self-supporting heat transfer modules; and
positioning the first module inside the internal cavity of the thermal energy storage vessel.
51. The method according to embodiment 50, further comprising steps of lifting and positioning a second module of the plurality of self-supporting modules inside the internal cavity of the thermal energy storage vessel, and abutting a first cell wall of the second module against a first cell wall of the first module.
52. The method according to embodiment 51, further comprising steps of lifting and positioning a third module of the plurality of self-supporting modules inside the internal cavity of the thermal energy storage vessel, abutting a first cell wall of the third module against a second cell wall of the first module, and abutting a second cell wall of the third module against a second cell wall of the second module.
53. The method according to embodiment 52, wherein the second cell wall of first module is adjacent to the first cell wall of the first module, and the second cell wall of the second module is adjacent to the first cell wall of the second module.
54. The method according to embodiments 52 or 53, wherein the first, second, and third modules each have a hexagonal transverse cross section forming hexagonal a heat transfer cell in each module.
55. The method according to any one of embodiments 52-54, further comprising separately filling each of the first, second, and third modules with a thermal mass composition comprised of granular particles operable to store thermal energy.
56. The method according to embodiment 55, wherein the thermal mass composition inside each module is isolated from the thermal mass composition inside the other modules.
57. The method according to any embodiment 56, wherein the first and second tube bundles of each heat exchanger in each of the first, second, and third modules are fluidly isolated from each other.
58. The method according to embodiment 57, wherein the first and second tube bundles each comprise a plurality of heat exchanger tubes which are exposed directly to the thermal mass composition inside each of the first, second, and third modules.
59. The method according to embodiments 57 or 58, wherein the first tube bundle is configured to circulate a heat transfer fluid heated by a solar energy system through the thermal mass composition in each of the first, second, and third modules to heat the thermal mass composition, and the second tube bundle is configured to circulate water through the thermal mass composition in each of the first, second, and third modules to absorb heat from the thermal mass composition and change phase to steam.
60. The method according to embodiment 51, wherein the steps of lifting and positioning the first and second modules inside the thermal energy storage vessel includes seating bottom ends of the first and second modules on a bottom closure plate of the thermal energy storage vessel.
61. The method according to any one of embodiment 50-60, wherein the first module includes a baseplate welded to a bottom end of the tubular structure.
62. The method according to embodiment 54, wherein the first, second, and third modules form a portion of a honeycomb pattern of heat transfer cells in the thermal energy storage vessel.
63. A solar energy system comprising:
a thermal energy storage vessel defining an internal cavity comprising a partition structure forming a plurality of isolated heat transfer cells each containing a separate inventory of a thermal mass composition operable to store thermal energy;
a first closed flow loop configured to circulate a heat transfer fluid, the first closed flow loop comprising a first tube bundle disposed in a first one of the isolated heat transfer cells;
a solar collector operably coupled to the first closed flow loop and configured to absorb solar energy and heat the heat transfer fluid in the first closed flow loop, the first tube bundle transmitting heat from the heat transfer fluid to the thermal mass composition in the first one of the isolated heat transfer cells; and
a second closed flow loop configured to circulate a working fluid, the second closed flow loop comprising a second tube bundle disposed in the first one of the isolated heat transfer cells, the second working fluid being heated by absorbing stored thermal energy from the thermal mass composition in the first one of the isolated heat transfer cells.
64. The system according to embodiment 63, wherein each isolated heat transfer cell is formed by a plurality of intersecting vertical cell walls that defines the isolated heat transfer cell.
65. The system according to embodiment 64, wherein the first one of the isolated heat transfer cells comprises a heat exchanger supported by the cell walls, the first and second tube bundles being an integral part of the heat exchanger.
66. The system according to embodiment 65, wherein tubes of the first and second tube bundles are exposed and embedded directly in the thermal mass composition in the first one of the isolated heat transfer cells.
67. The system according to embodiment 66, wherein the first and second tube bundles are coupled to and supported by a top header assembly of the heat exchanger.
68. The system according to any one of embodiments 65-67, wherein the thermal mass composition inside each isolated heat transfer cell is physically isolated from the thermal mass composition of adjacent heat transfer cells by the cell walls, each isolated heat transfer cell and heat exchanger being independently operable of the other isolated heat transfer cells and heat exchangers.
69. The system according to embodiment 68, wherein the cell walls of each isolated heat transfer cell have bottom ends abuttingly engaged with a bottom closure plate of the thermal energy storage vessel to prevent the thermal mass composition in each isolated heat transfer cell from comingling with the thermal mass composition of adjacent isolated heat transfer cells at a bottom of the isolated heat transfer cells.
70. The system according to any one of embodiments 63-69, wherein the isolated heat transfer cells each have a hexagonal configuration and are arranged to collectively form a honeycomb partition structure inside the thermal energy storage vessel.
71. The system according to any one of embodiments 63-70, wherein the thermal mass composition inside each isolated heat transfer cell comprises a mixture of granular particles including a phase change material and metal particles, the phase change material having a lower melting temperature than the metal particles.
72. The system according to embodiment 71, wherein the thermal mass composition comprises a fine blend of iron ore, steel powder, and the phase change material is copper-alloy based eutectic.
73. The system according to any one of embodiments 63-72, further comprising a plurality of electric energy injector units disposed in an empty peripheral region extending perimetrically around the internal cavity of the thermal energy storage vessel between the partition structure and an outer shell of the thermal energy storage vessel, each electric energy injector unit comprising a tank which receives and circulates a portion of the heat transfer fluid from the first closed flow loop therethrough and a plurality of electric heaters operable to heat the heat transfer fluid.
74. The system according to embodiment 73, wherein each electric energy injector unit comprises a pump fluidly coupled to the first closed flow loop which conveys heat transfer fluid to the tank.
75. The system according to embodiment 74, wherein each electric energy injector unit is mounted adjacent a top end of the heat transfer cells and supported by the cell walls of the cells.
76. The system according to any one of embodiments 73-75, wherein the electric energy injector units are perimetrically spaced apart in the peripheral region of the thermal energy storage vessel.
77. The system according to any one of embodiments 73-76, wherein the electric heaters are electrically connected to a photovoltaic array of solar panels.
78. The system according to embodiment 77, wherein the solar panels are configured to absorb solar energy and generate electric power.
79. The system according to any one of embodiments 73-78, wherein each electric heater is an immersion type heater having elements protruding into the tank to contact the heat transfer fluid.
80. The system according to any one of embodiments 63-72, wherein the second closed flow loop comprises a turbogenerator operable to generate electricity.
81. A method for operating a solar energy system with thermal energy storage, the method comprising:
providing or having a thermal storage energy vessel comprising a plurality of heat transfer cells each including an inventory of a thermal mass composition operable to store heat and a heat exchanger comprising first and second tube bundles embedded in the thermal mass composition, the first tube bundle configured to convey a heat transfer fluid heated by a solar collector of the solar energy system and a second tube bundle configured to convey a working fluid, the thermal mass composition in each heat transfer cell isolated from the thermal mass composition of the other cells so as to be independently operable from the other cells;
heating the heat transfer fluid in a solar collector of the solar energy system to produce heated heat transfer fluid;
heating a first one of the plurality of heat transfer cells to a first temperature via flowing the heat transfer fluid through the heat exchanger in the first one of the plurality of heat transfer cells;
heating a second one of the plurality of heat transfer cells to a second temperature via flowing the heat transfer fluid through the heat exchanger in the second one of the plurality of heat transfer cells, the second temperature being different than the first temperature.
82. The method according to embodiment 81, wherein the first and second tube bundles of the heat exchangers are in direct conformal contact with the thermal mass composition in the first and second ones of the plurality of heat transfer cells.
83. The method according to embodiment 82, further comprising heating the working fluid in the first one of the plurality of heat transfer cells to a first temperature and heating the same or a different working fluid in the second one of the plurality of heat transfer cells to a second temperature different than the first temperature.
84. The method according to embodiment 83, wherein the working fluid is water which is heated in the first one of the plurality of heat transfer cells to superheated steam, and the water is heated in the second one of the plurality of heat transfer cells to produce saturated steam or heated water in a liquid phase.
85. The method according to embodiments 83 or 84, wherein the heated heat transfer fluid in the first and second ones of the plurality of heat transfer cells transfers heat to the thermal mass composition which in turn transfers heat to the working fluid.
86. The method according to any one of embodiments 81-85, wherein the heat transfer fluid is molten salt or a synthetic heat transfer oil.
87. A solar energy system comprising:
a thermal energy storage system comprising a vessel forming an internal cavity containing a thermal mass composition operable to store thermal energy; and
a conjugate heat exchanger comprising:
   a first tube bundle embedded in the thermal mass composition and configured to receive and circulate a heat transfer fluid heated by a solar collector of the solar energy system to heat the thermal mass composition; and
   a second tube bundle embedded in the thermal mass composition and configured to receive and circulate a working fluid which is heated via absorbing heat from the thermal mass composition.
88. The system of embodiment 87 wherein the conjugate heat exchanger further comprises at least one header assembly, the first and second tube bundles coupled to and supported by the at least one header assembly.
89. The system according to embodiment 88, wherein the conjugate heat exchanger is vertically oriented.
90. The system according to embodiment 89, wherein the at least one header assembly is a top header assembly disposed at a top end of the first and second tube bundles.
91. The system according to embodiment 90, wherein the top header assembly includes a first header defining a heat transfer fluid plenum fluidly coupled to the first tube bundle, and an adjacent second header defining a working fluid outlet plenum fluidly coupled to the second tube bundle, the heat transfer fluid plenum fluidly isolated from the working fluid outlet plenum.
92. The system according to embodiment 91, wherein the heat transfer fluid plenum is divided by a partition plate into a heat transfer fluid inlet plenum and heat transfer fluid outlet plenum.
93. The system according to embodiment 92, wherein the first header includes a first tubesheet to which top ends of first tubes of the first tube bundle are coupled, and the second header includes a second tubesheet to which top ends of second tubes of the second tube bundle are coupled, the first and second tubesheets being spaced apart to define the heat transfer fluid plenum therebetween.
94. The system according to embodiment 93, wherein the second tubes pass through the first tubesheet and the heat transfer fluid plenum to the second tubesheet.
95. The system according to embodiment 94, wherein the second tubes are slideably received through the first tubesheet without being affixed thereto to allow the second tubes to expand relative to the first tubesheet.
96. The system according to any one of embodiments 91-95, wherein the second header has a spherical shape comprising a bottom half and a top half detachably coupled to the bottom half.
97. The system according to embodiment 96, wherein the bottom half defines the second tubesheet which is arcuately curved and welded to the first header such that the second tubesheet protrudes downwards into the heat transfer fluid plenum.
98. The system according to embodiments 96 or 97, wherein the top half of the working fluid outlet header is arcuately curved forming a steam dome configured to collect the steam from the second tubes of the second tube bundle.
99. The system according to any one of embodiments 91-98, further comprising a bottom heat transfer fluid return header fluidly coupled to bottom ends of the first tubes of the first tube bundle, and a bottom working fluid inlet header fluidly coupled to bottom ends of the second tubes of the second tube bundle.
100. The system according to embodiment 99, further comprising a working fluid downcomer having a portion extending through the first and second tube bundles which is coupled to the bottom working fluid inlet header.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A solar energy system comprising:
a thermal energy storage system comprising a vessel forming an internal cavity;
a partition structure dividing the internal cavity into at least two heat transfer cells;
each of the at least two heat transfer cells containing an inventory of a thermal mass composition; and
a heat exchanger disposed in each of the at least two heat transfer cells, each heat exchanger comprising a first tube bundle embedded in the thermal mass composition.

2. The system according to claim 1, wherein the first tube bundles of the heat exchangers are in fluid communication with a first common fluid source; and wherein each of the first tube bundles of the heat exchangers can be independently isolated from the common fluid source while allowing the other ones of the heat exchangers to remain in operable fluid communication with the first common fluid source.

3. The system according to claim 2, wherein each of the heat exchangers are independently operable.

4. The system according to claim 1, wherein the thermal mass composition inside each heat transfer cell is operable to store heat and isolated from the thermal mass composition of the other heat transfer cells.

5. The system according to claim 1, wherein the vessel comprises an outer shell defining a sidewall, and a bottom closure plate coupled to a bottom end of the shell.

6. The system according to claim 5, wherein each of the at least two heat transfer cells is vertically elongated and formed by vertical cell walls which extend upwards from the bottom closure plate.

7. The system according to claim 6, wherein the cell walls of each of the at least two heat transfer cells have bottom ends abuttingly engaged with the bottom closure plate of the vessel to prevent the thermal mass composition in each cell from substantially comingling with the thermal mass composition of the other cells.

8. The system according to claim 7, wherein the bottom ends of cell walls of the heat transfer cells are fixedly coupled to the bottom closure plate.

9. The system according to claim 5, wherein the cell walls of each heat transfer cell extend for at least 90 percent of a height of the internal cavity of the vessel.

10. The system according to claim 1, wherein the partition structure is configured to form the at least two heat transfer cells with a polygonal transverse cross-sectional shape.

11. The system according to claim 10, wherein the at least two heat transfer cells have a hexagonal transverse cross-sectional shape.

12. The system according to claim 2, wherein each heat exchanger further comprises a second tube bundle embedded in the thermal mass composition in each of the at least two heat transfer cells, the second tube bundles each in fluid communication with a second common fluid source different than the first common fluid source.

13. The system according to claim 12, wherein the first common fluid source comprises a first closed flow loop circulating a heated heat transfer fluid which heats the thermal mass composition in each of the at least two heat transfer cells, and the second common fluid source comprises a second closed flow loop circulating a working fluid heated via absorbing heat from the thermal mass composition.

14. The system according to claim 13, wherein the first closed flow loop comprises a solar collector which heats the heat transfer fluid via sunlight, the working fluid changes phase in each heat exchanger from a liquid to steam via absorbing heat from the thermal mass composition, and the closed flow loop comprises a turbogenerator of a Rankine power generation system which receives the steam to generate electricity.

15. The system according to claim 12, further comprising a plurality of radially extending support beams which support each heat exchanger in the at least two heat transfer cells in a vertically suspended manner from the partition structure.

16. The system according to claim 15, wherein a first end of each support beam is coupled to the heat exchanger and an opposite second end of the support beam is coupled to a top end of the cell walls of the at least two heat transfer cells.

17. The system according to claim 12, wherein each of the at least two heat transfer cells is formed by a self-supporting transportable heat transfer module with a tubular structure formed by a plurality of the cells walls.

18. (canceled)

19. The system according to claim 17, further comprising a baseplate coupled to bottom ends of the cells walls of each heat transfer cell, the baseplate configured to rest on a top surface of the bottom closure plate of the vessel.

20. The system according to claim 12, wherein each heat exchanger comprises a stacked top header assembly including a first header defining a heat transfer fluid plenum fluidly coupled to the first tube bundle, and an adjacent second header defining a working fluid outlet plenum fluidly coupled to the second tube bundle, the heat transfer fluid plenum fluidly isolated from the working fluid outlet plenum.

21. The system according to claim 20, wherein the heat transfer fluid plenum is divided by a partition plate into a heat transfer fluid inlet plenum and heat transfer fluid outlet plenum.

22. The system according to claim 21, wherein the first header includes a first tubesheet to which top ends of first tubes of the first tube bundle are coupled, and the second header includes a second tubesheet to which top ends of second tubes of the second tube bundle are coupled, the first and second tubesheets being spaced apart to define the heat transfer fluid plenum therebetween, and wherein the second tubes pass through the first tubesheet and the heat transfer fluid plenum to the second tubesheet.

23. (canceled)

24. The system according to claim 22, wherein the second tubes are slideably received through the first tubesheet without being affixed thereto.

25. The system according to claim 22, wherein the second header has a spherical shape comprising a bottom half and a separate top half detachably coupled to the bottom half, wherein the bottom half defines the second tubesheet which is arcuately curved and welded to the first header such that the second tubesheet protrudes downwards into the heat transfer fluid plenum, and wherein the top half of the working fluid outlet header is arcuately curved forming a steam dome including a centered outlet nozzle.

26-100. (canceled)
